(19) United States
(12) Patent Application Publication
(10) Pub. No.: US 2002/0026359 A1
(43) Pub. Date: Feb. 28, 2002

(54) Targeted advertising method and system

(76) Inventors: Kenneth W. Long, Monroe, NC (US); Michael B. Robinson, Churchville, MD (US); Robert N. Glezen, Duluth, GA (US); Christopher M. Jenkins, Woodstock, GA (US); Douglas J. Mazur, Lilburn, GA (US)

Correspondence Address: Kenneth E. Krosin, FOLEY & LARDNER, Washington Harbour, 3000 K Street, N.W., Suite 500, Washington, DC, 20007-5109, US

(21) Appl. No.: 09/789,965

(22) Filed: Feb. 22, 2001

Related U.S. Application Data
(60) Provisional application No. 60/183,921, filed on Feb. 22, 2000.

(51) Int. Cl. G06F 17/60

(52) U.S. Cl. 705/14

(57) ABSTRACT

A method of targeted advertising includes generating a targeted advertising and/or promotional campaign material corresponding to a client's selections, fulfilling the targeted advertising and/or promotional campaign material, and providing a response tracking analysis to the client. The targeted advertising and/or promotional campaign material includes a response tracking capability. Access for the client to contact a central facility having public and/or private client databases with list management capabilities can be provided on-line via a client web site. The client can choose from a selection of templates to design of the targeted advertising and/or promotional campaign material. Also, the client can choose from a selection of intended recipients by using and/or modifying a new or pre-existing customer list. The targeted advertising and/or promotional campaign material can be manufactured and distributed to the intended recipients. Preferably, the advertising and/or promotional campaign material includes a coupon having a machine readable mark, symbol, or barcode that incorporates information relating to the client, the customer, and the advertising and/or promotional campaign. The scanned coupon can be communicated back to the central facility and the client can be notified by the central facility as to the response characteristics of the advertising and/or promotional campaign. A closed-loop system is also provided that can implement the above targeted advertising method.

### CROSS REFERENCE TO RELATED APPLICATIONS

This application claims benefit of priority from Provisional Application Ser. No. 60/183,921, filed on Feb. 22, 2000, entitled “Direct Mail Now E-Commerce System,” incorporated by reference in its entirety herein.

### BACKGROUND OF THE INVENTION

A. Field of the Invention

The invention relates generally to the field of electronic services and, more particularly, to a method and system for closed-loop targeted advertising.

B. Description of the Related Art

Targeted advertising and promotional campaigns have been utilized in the field of advertising for many years. Typically a direct mail campaign is used to target a potential customer, often of a particular demographic group, such as age, wealth, location, and the like, to generate interest in a merchant's products. Typically, such a targeted advertising or promotional campaign involves many time consuming steps: (1) creating the advertising material (e.g., letter, survey, or the like); (2) producing multiple copies of the advertising material; (3) either placing an order to generate direct mail including the advertising material or self-generating the directed advertisement; (4) purchasing a customer list of multiple potential customers; (5) physically creating the mailing by folding, sealing, producing labels, applying postage, and delivering the mailing to a post office; and (6) having to hire an outside consultant to determine the effectiveness of the campaign or analyze the survey results.

Recently, various electronic commerce (“e-commerce”) services have become available to the public via the Internet. In particular, services are available to process document correspondence for subscribers of a particular service. These are generally transaction based services where a client can submit an on-line order for the printing and mailing of a particular document. The documents may be authored by the customer from several document types and styles that are authored by the service. Once the order is placed, the document style, quantity and addressee list are forwarded in an electronic file format to the service provider who prints, posts, and mails the documents.

One problem with the aforementioned type of Internet service is that pre-authored and pre-formatted documents of a generic nature are offered to appeal to the broadest possible customer base. Alternatively, the client/merchant can customize the documents, but assumes full overhead costs in this instance.

The present invention is directed to overcoming or at least reducing the effects of one or more of the problems set forth above.

### SUMMARY OF THE INVENTION

In view of the foregoing, according to a first embodiment of the present invention, a method of targeted advertising comprises generating a targeted advertising and/or promotional campaign material at a central facility corresponding to a client's selections, fulfilling the targeted advertising and/or promotional campaign material, and providing a response tracking analysis to the client. The targeted advertising and/or promotional campaign material includes a response tracking capability. In addition, the method can further include providing access for the client to contact a central facility on-line via a client web site, providing a set of options for the client to choose from in selecting a design of the targeted advertising and/or promotional campaign material, and providing a set of options for the client to choose from in selecting intended recipients of the targeted advertising and/or promotional campaign material.

The fulfilling step can comprise manufacturing the targeted advertising and/or promotional campaign material and distributing the targeted advertising and/or promotional campaign material to the intended recipients. The advertising and/or promotional campaign material can be at least one material selected from the group consisting of a document, a direct mail letter, a coupon, a flyer, and a postcard. Preferably, the advertising and/or promotional campaign material includes a coupon having a machine readable mark, symbol, or barcode that incorporates information relating to the client, the customer, and the advertising and/or promotional campaign. The machine readable mark, symbol, or barcode can be scanned and the information incorporated on the machine readable mark, symbol, or barcode can be electronically stored by a party receiving the coupon. In addition, the scanned coupon can be communicated back to the central facility and the client can be notified by the central facility as to response characteristics of the advertising and/or promotional campaign. In this method, the response tracking capability allows the client to determine whether a particular customer received and utilized the advertising and/or promotional campaign material.

According to another embodiment of the present invention, a method of generating an advertisement, comprises providing a client access to a central facility to create an advertising and/or promotional material, providing a database administered by the central facility that includes an electronically storable advertising and/or promotional template from which the client selects the format and content of the advertising and/or promotional material, and providing a customer list from which the client selects targeted customers of the advertising and/or promotional material. The method also includes processing data corresponding to the selected advertising and/or promotional material and data corresponding to the selected targeted customers, providing an order that identifies the processed advertising and/or promotional material data and targeted customer data, and communicating the order for fulfillment. In addition, response tracking data that relates the client, a particular customer from the targeted customers, and the order is processed and the advertising and/or promotional material is generated in communicable form for receipt by the targeted customers, where the communicable form includes a machine readable mark or code that includes the response tracking data.

Other advantages and novel features of the present invention will become apparent from the following detailed description of the invention when considered in conjunction with the accompanying drawings.

### BRIEF DESCRIPTION OF THE DRAWINGS

The foregoing advantages and features of the invention will become apparent upon reference to the following detailed description and the accompanying drawings, of which:

FIG. 1 shows a flow diagram of a targeted advertising/promotional method according to an embodiment of the present invention.

FIG. 2 shows a flow diagram of a process for generating a targeted advertising and/or promotional material according to another embodiment of the present invention.

FIG. 3 shows a flow diagram of a process for fulfilling a targeted advertising and/or promotional material order according to another embodiment of the present invention.

FIG. 4 shows a flow diagram of a process for providing response tracking analysis of a targeted advertising and/or promotional campaign according to another embodiment of the present invention.

FIG. 5 shows a flow chart of a closed-loop targeted advertising method for a direct mail campaign with response tracking capability according to a preferred embodiment of the present invention.

FIG. 6 shows an example barcode and the portions of the barcode that can contain response tracking data.

FIGS. 7A-7C and 8-20 show a detailed example of the targeted advertising and/or promotional campaign generation process performed via a web browser application according to a preferred embodiment of the present invention.

FIG. 21 shows a flow diagram and system in schematic form for an example fulfillment process according to another embodiment of the present invention.

FIG. 22 shows an example template of a direct mail advertisement.

FIG. 23 shows an example printer version XML document utilized to print the direct mail advertisement at the printer according to another embodiment of the present invention.

FIG. 24 shows a schematic view of a system that can be utilized to create and manufacture a targeted advertisement and/or promotional material with response tracking capability according to yet another embodiment of the present invention.

FIG. 25 shows an overview schematic diagram of a relational database utilized to provide list management and client configuration information at a central facility according to yet another embodiment of the present invention.

FIGS. 26A-26Q show various tables within an example relational database according to a preferred aspect of the present invention.

### DETAILED DESCRIPTION OF SPECIFIC EMBODIMENTS

The present invention is directed to a method and system for targeted advertising. In particular, the present invention (including various embodiments thereof) provides a process for generating a targeted advertising and/or promotional material, a process for generating a targeted advertising and/or promotional material, and a process for providing response tracking analysis of a targeted advertising and/or promotional campaign. In particular, a closed-loop targeted advertising method for a direct mail campaign is provided that includes response tracking capability to allow a client (or user) to track and evaluate the effectiveness of a targeted advertising and/or promotional campaign within an enclosed environment. In this manner, a response analysis process can be continually updated and provided to the client that can directly tie a particular customer to a particular purchase (i.e., an actual response) in a fully integrated manner. With this capability, a client can better target and fully tailor subsequent advertising and promotional campaigns. The aforementioned methods, processes, and systems will now be described in greater detail.

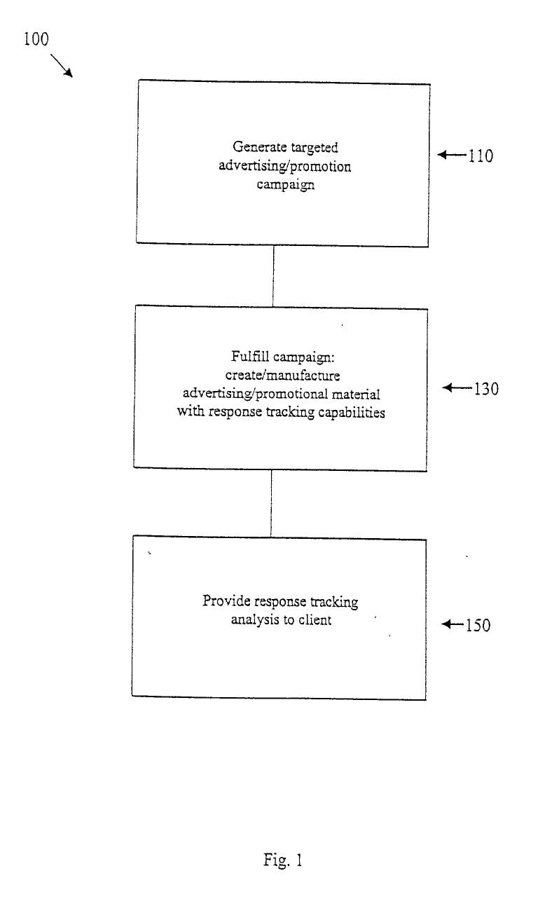

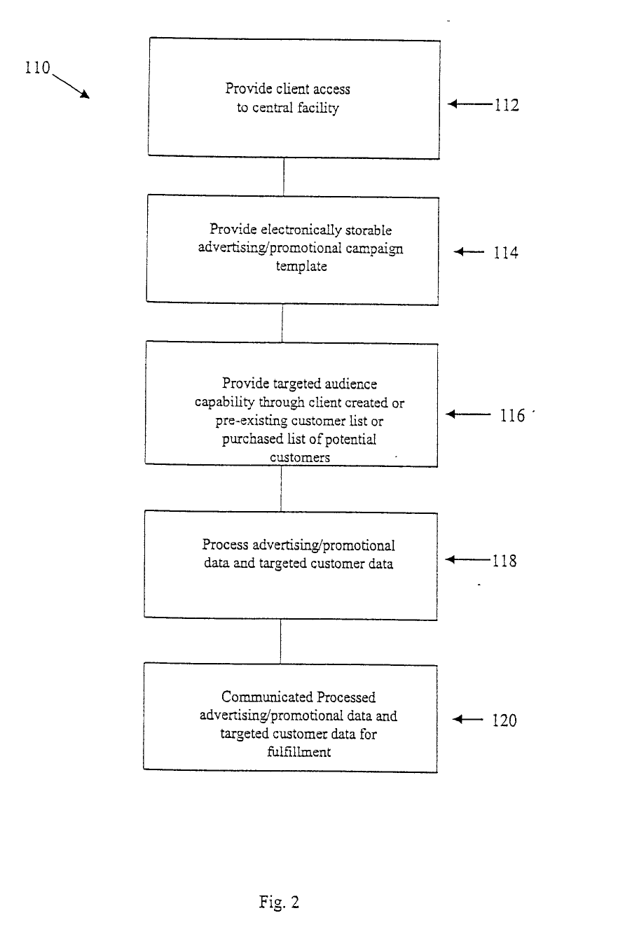

FIG. 1 shows a flow diagram of a targeted advertising and/or promotional method 100 according to an embodiment of the present invention. In step 110, a client generates a targeted advertising and/or promotional campaign. For example, the client can be a national or locally based corporation, a merchant, or any member of the public. The advertising and/or promotional campaign is a communication that the client desires to distribute to a particular audience. Preferably, the client contacts a central facility on-line via its web site to generate the advertising and/or promotional campaign.

In step 130, the advertising and/or promotional campaign is fulfilled. The fulfillment can be accomplished by creating or manufacturing an advertising and/or promotional material, such as a letter, coupon, flyer, postcard, or the like. For example, the promotional material can be a coupon which is physically generated by the central facility or a printing service in contact with the central facility. In addition, according to a preferred aspect of the present invention, the promotional material can include a response tracking capability. The response tracking capability allows the client to determine whether a particular customer received and utilized the promotional material. For example, the coupon can include a barcode or the like which incorporates information relating to the client, the customer, the product, the date of the advertisement, and the like, which can be scanned and stored by a merchant receiving the coupon.

In step 150, a response tracking analysis is provided to the client. For example, the scanned coupon is communicated back to the central facility. The client is then alerted or notified by the facility as to the response characteristics of the advertising and/or promotional campaign. Each of these steps will be discussed in greater detail with reference to FIGS. 2-4.

FIG. 2 shows a preferred method of implementing step 110. In step 112, a client is given access to a central facility which can be used to automatically generate the advertising and/or promotional campaign. For example, the central facility can offer on-line (dial-up) or Internet-based services to the client. Alternatively, a closed intranet can be established between the client and the central facility to enable access to the central facility by the client or an entity given permission by the client.

In step 114, for example, the client can be given access to electronically storable advertising and/or promotional campaign template. Preferably, the client can choose from a library of advertising, promotional and/or correspondence templates and select a targeted advertising and/or promotional material that is best suited to the type of campaign being generated. The template can be altered or modified based on the client's desires. Alternatively, the client can create his or her own advertising material through the central facility.

Once the advertising and/or promotional campaign material is generated, in step 116, the client can select the targeted audience to which the advertising and/or promotional campaign material is to be communicated. For example, if the client is an existing client, the central facility will provide access to a previously used customer list that is stored in a private client library at the central facility. Alternatively, the central facility can allow the client to purchase a new customer list to use separate from or in conjunction with the preexisting customer list for that client. In addition, the central facility can allow the client to choose a specific demographic group that is the targeted audience of the advertising and/or promotional campaign. The client can then select the intended target audience.

In step 118, the central facility processes the advertising and/or promotional campaign material data and targeted customer data. In step 120, an order that includes the processed advertising and/or promotional campaign material data and targeted customer data is generated for fulfillment.

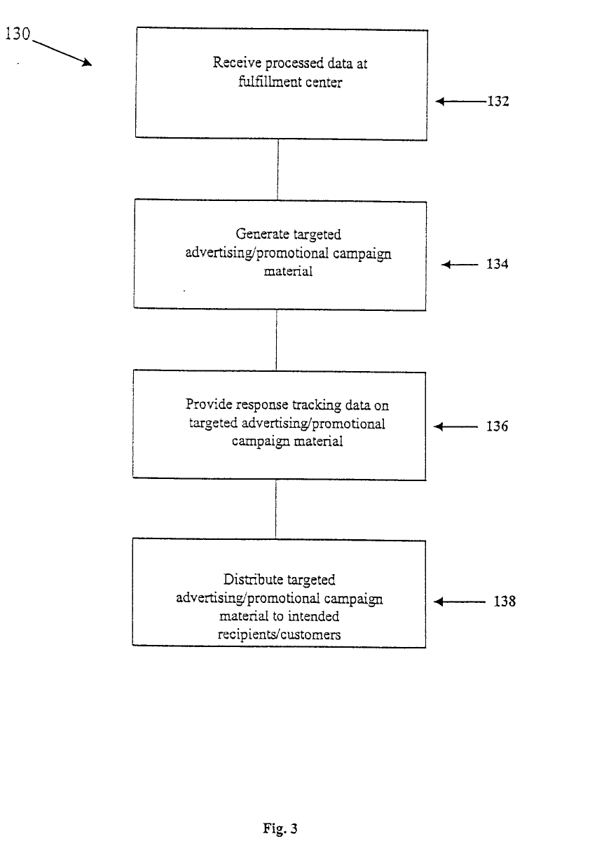

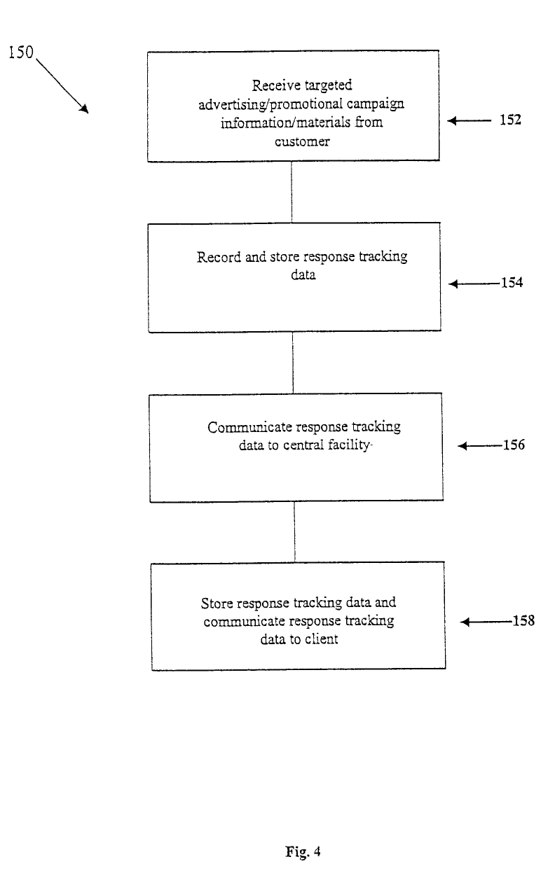

FIG. 3 shows a preferred embodiment of fulfillment step 130. In step 132, the order containing the processed advertising and/or promotional campaign material data and targeted customer data is received for fulfillment. The order can be fulfilled either at the central facility or it can be automatically communicated to a linked fulfillment center. In step 134, the fulfillment center then physically generates the targeted advertising and/or promotional campaign material so that it can be communicated to its intended recipients (i.e., the targeted customers). For example, if the client is selecting a direct mail campaign, the advertising and/or promotional campaign material is printed in the form of a letter, flyer, coupon, postcard, or the like. Alternatively, if the client selects an e-mail campaign, the targeted e-mail is generated and prepared to send to the intended e-mail customer addresses.

In addition, during the physical generation of the targeted advertising and/or promotional campaign materials, in step 136, response tracking data is generated and processed for inclusion on the targeted advertising and/or promotional campaign materials. As mentioned previously, the response tracking data provides information relating to several aspects of the campaign. For example, the tracking data can include the name of the order or offer, the intended customer's name, the name of the client, the order type, the date mailed, and/or other particular information. In a preferred embodiment, this information can be included on the targeted advertising and/or promotional campaign material in the form of a barcode or other type of machine readable mark, symbol or lettering. According to a preferred embodiment of the present invention, the central facility can generate this response tracking data automatically to provide the client with a response analysis of a particular advertising and/or promotional campaign. Thus, during fulfillment of the customer's order, the barcode or other machine readable mark is printed on the targeted advertising and/or promotional campaign material. To complete fulfillment, the generated materials are then communicated to customers via mail, courier service, voice, fax, digital communication or electronic mail in step 138.

FIG. 4 shows a preferred embodiment of response tracking analysis step 150. In step 152, the targeted advertising and/or promotional campaign material, which was received by an intended recipient customer, is communicated to a merchant from the customer. For example, if the target promotional material is a discount coupon, the customer redeems the coupon at a particular store when purchasing the discounted item. In step 154, preferably, the merchant selling the discounted item then records and stores the promotional material. For example, if the promotional material is a coupon having a barcode or mark containing response tracking information, the merchant can scan or electronically read the barcode or mark. In one example, the tracking information is stored in a memory of a computer at the merchant site.

In step 156, the response tracking information is then communicated to the central facility. For example, the merchant can access the central facility web site, whereupon the response tracking information is automatically synchronized to the central facility. Other conventional methods of communicating electronic information can also be utilized. Alternatively, if the merchant does not utilize a scanner or similar mechanism, once the coupon or other promotional material is redeemed, the merchant can then forward the coupon/promotional material to the central facility via mail or courier. The coupon can then be scanned at the central facility or other location.

In step 158, the response tracking information is then stored at the central facility and the response data is communicated to the client. Storage of the response tracking information can be maintained at a private library for the client identified in the response tracking information. For example, when the client accesses the central facility's web site, the response tracking information for some or all of the client's advertising and/or promotional campaigns is available for viewing by the client, if so desired. Thus, according to a preferred embodiment of the present invention, a client can have an immediate and updated response analysis at any time.

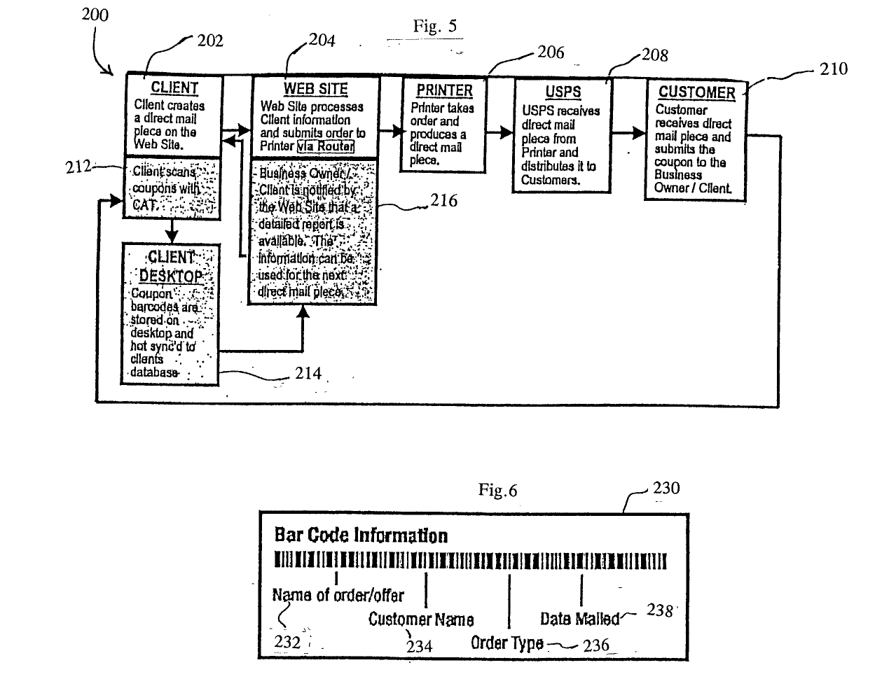

A preferred embodiment of a closed-loop targeted direct mail campaign is described below with respect to FIG. 5. For purposes of this description, closed-loop means that the targeted advertisement (e.g., direct mail) and response tracking information are contained within the same client-central facility relationship and automatically linked so that relevant and updated customer and client information is accessible by the client to provide results analysis of the particular advertising and/or promotional campaign.

In step 202, a client creates a direct mail piece on the web site of a central facility. In this step, the client has access to a library of direct mail advertising and promotional templates. The library can be a general library of templates or a private library devoted to the client. In addition, as discussed above, the client can select a previously used customer list, purchase a new customer list, or modify a customer list with client-entered or client-purchased customer information.

By way of example, for purposes of this description, it is assumed that the client is an owner of a hair salon and the advertising material or piece is a set of three coupons: coupon 1 is for a 10% discount on a haircut; coupon 2 is for a 10% discount on a manicure; and coupon 3 is for $2.00 off a bottle of conditioner. In this example, the client modifies a previously used promotional piece stored in a private template library and existing customer list that is stored in a private list library. The modification includes purchasing a list that is based on the following demographic: individuals ages 25-39 residing within 5 miles of the hair salon.

In step 204, the web site processes the client information and submits an order to a fulfillment center, in this example, a printer service associated with the central facility. In addition, because the client is an existing client, all payment information can be stored in a suitable client database at the central facility to further speed up the process of implementing the order.

In step 206, the printer service takes the order and produces a direct mail material or piece. In this example, the direct mail letter includes the aforementioned 3 coupons. As discussed above, response tracking analysis is available by incorporating response tracking information directly within the direct mail material or piece. In this example, the response tracking information is provided in the form of a barcode or machine readable mark included on each of the coupons. As discussed further below, each barcode or mark can be different based on the client, the targeted advertisement order, the product, the customer, etc.

In step 208, the postal service receives the direct mail from the printer and distributes it to customers. In step 210, the customer receives the direct mail material or piece.

In step 212, the customer uses the direct mail material or piece at the client's business or store, whereupon the client scans the coupon. In this example, the customer purchases a discounted haircut, but does not purchase the conditioner or a manicure.

In step 214, the scanned information is stored in memory of the client's computer. The stored information is also hot sync'd to the client's database at the central facility. In this manner, the client's database at the central facility is continually updated with response information.

In step 216, the client (e.g., hair salon owner) is notified by the central facility website that a detailed response analysis report is available. This response information can then be utilized to better tailor the next campaign. For example, the hair salon owner can view the results of the most recent campaign. Thus, the salon owner can have access to the following information: the overall response of the campaign, the name of the customer, the type of product purchased by the customer, and the date purchased. The salon owner can utilize this information in subsequent promotional campaigns. For example, in this scenario, the response analysis can inform the client of the particular customer that purchased the haircut (using coupon 1), but did not utilize coupon 2 or coupon 3. If a subsequent promotion involves only advertising conditioners, this particular customer may or may not be excluded, depending on the client's advertising strategy.

FIG. 6 shows an example barcode 230 that can be included for response tracking analysis. In this example, the bar code includes different portions directed to different types of information: a first portion 232 that includes the name of the client order/offer; a second portion 234 that includes the name of the customer that the coupon was mailed to; a third portion 236 that includes the type of order; and a fourth portion 238 that includes the date of the coupon mailing. Other information can be included in the bar code or mark, such as the name of the client, etc., as would be apparent to one of ordinary skill in the art given the present description.

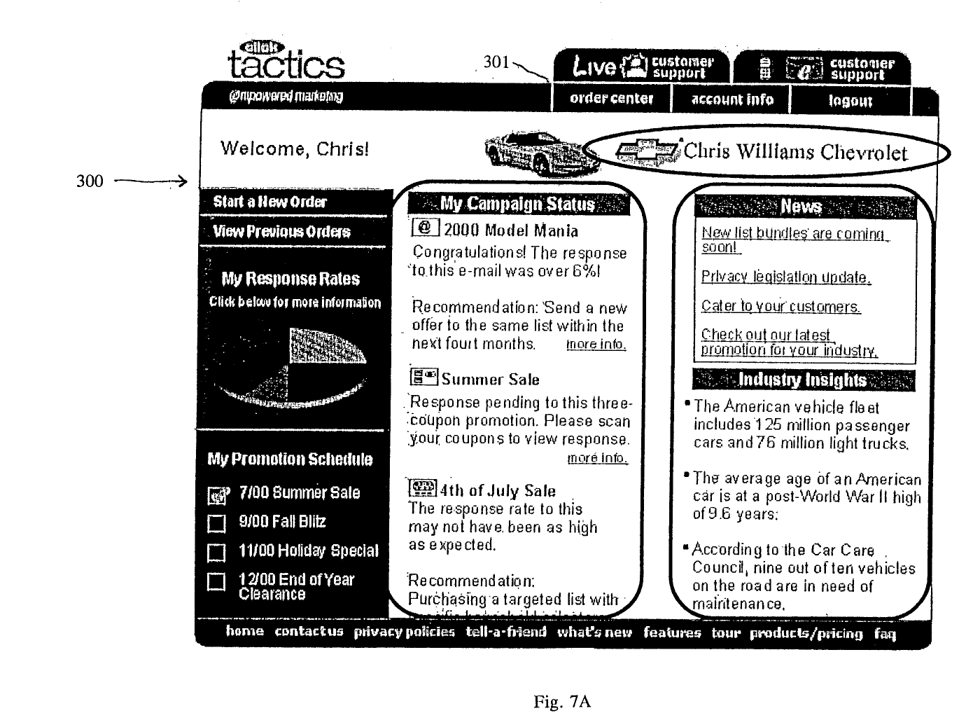

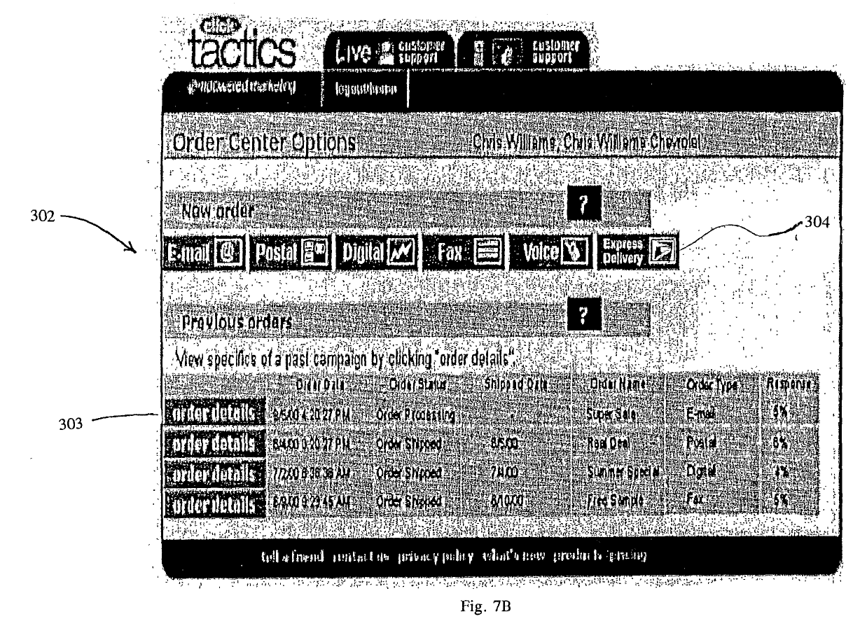

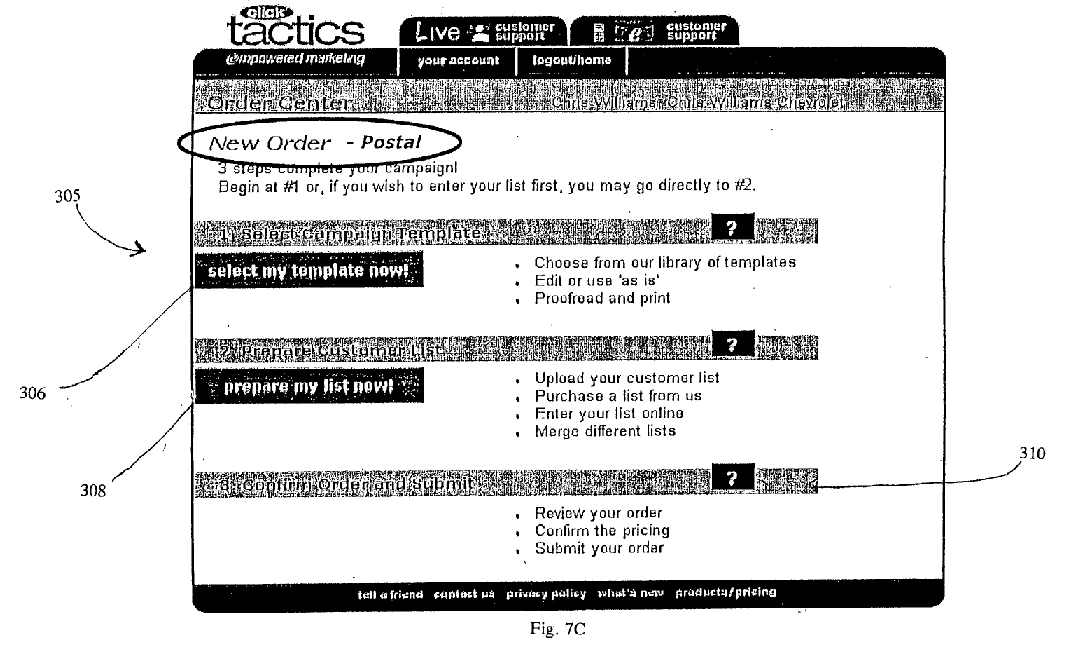

A detailed example of the targeted advertising and/or promotional campaign generation process is shown below with respect to FIGS. 7-20. In this example, the central facility is administered by Click Tactics®, the client is a car dealer that owns Chris Williams Chevrolet, and the client is accessing Click Tactics® via its web site on the Internet. The physical implementation of this type of communication, and the underlying software used to implement the web site, will be described in later sections of the description.

In a preferred embodiment, the client desiring to create a direct mail campaign contacts the central facility through accessing its web site. The information from the web site is provided to the user via a web browser. After typing in a password, the client, if a pre-existing client, such as in this example, accesses a customized welcome page.

FIG. 7A shows a welcome page 300, which is a customized web site designed at the central facility for the pre-existing customer. As shown on welcome page 300, the page can provide detailed information for that particular client relating to previous advertising/promotional campaigns, new product information, and recommendations. Alternatively, a community web site can be established to greet a new client interested in placing an order.

If the client chooses the order center option 301, an order center options page 302 is displayed, as shown in FIG. 7B. This page shows the general information relating to previous orders (e.g., order date, order status, shipped date, order name, order type, overall response) and allows the client the option of viewing detailed information by selecting option 303 for previous orders. In this example, the client selects a new postal order through new order prompt 304.

FIG. 7C shows a new direct marketing campaign order page 305. In a preferred embodiment, the client is presented with three main options: select campaign template, prepare customer list, and confirm order and submit. The confirm order option 310 can be selected after prompt 306 and 308 have been selected. To select a campaign template, the client can choose from a client facility library containing numerous possible templates. The client can also edit a selected template or use as is. The client can also proofread and print a sample copy before submitting an order.

As shown in prompt 308, the client can prepare a customer list. The client can prepare the customer list before or after selecting a campaign template. Utilizing this customer list preparation procedure, the client can upload a personal customer list (such as a list stored at a private client library at the client facility), purchase a customer list through the central facility, enter a new list on-line, and/or merge different lists.

After the client has selected a template and chosen a customer list, the client can place a direct mail campaign order using prompt 310. This prompt can allow the client to review the order, confirm the pricing, and submit the order.

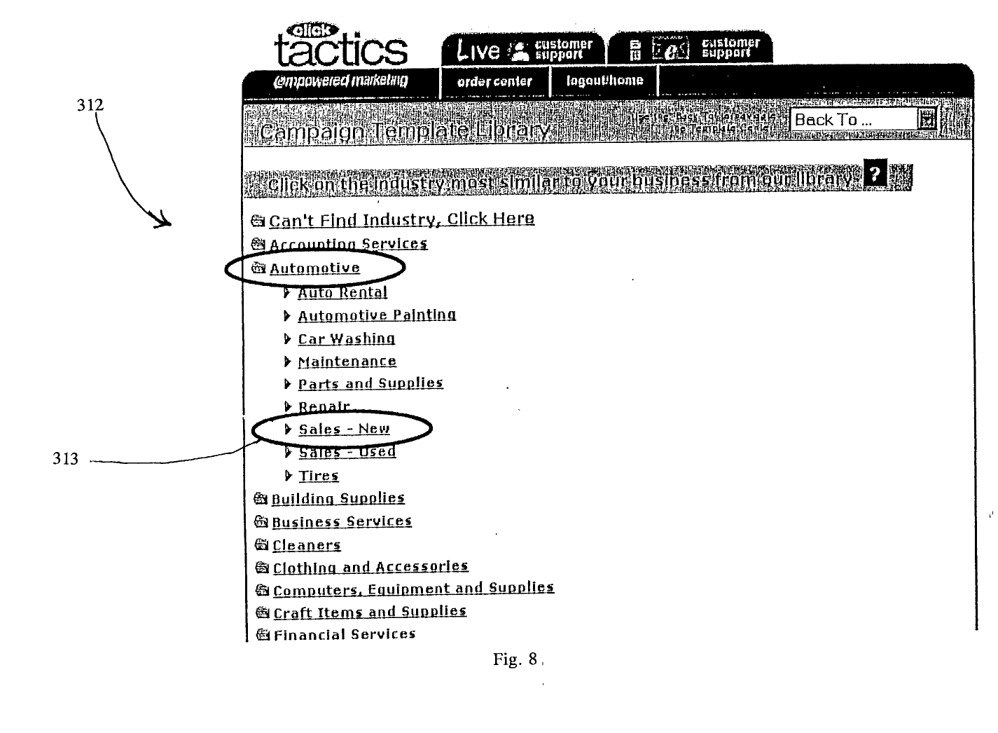

Assuming that the client has selected prompt 306, the client can choose a campaign template from a library of templates, as shown in web page 312 in FIG. 8. In this preferred configuration, the client can choose a template based on the type of industry/product the client wishes to advertise. In this example, the car dealer client selects “sales-new” (prompt 313) under “automotive.” and Other types of indexing arrangements of templates are also possible, as will be apparent to those of ordinary skill in the art given the present description.

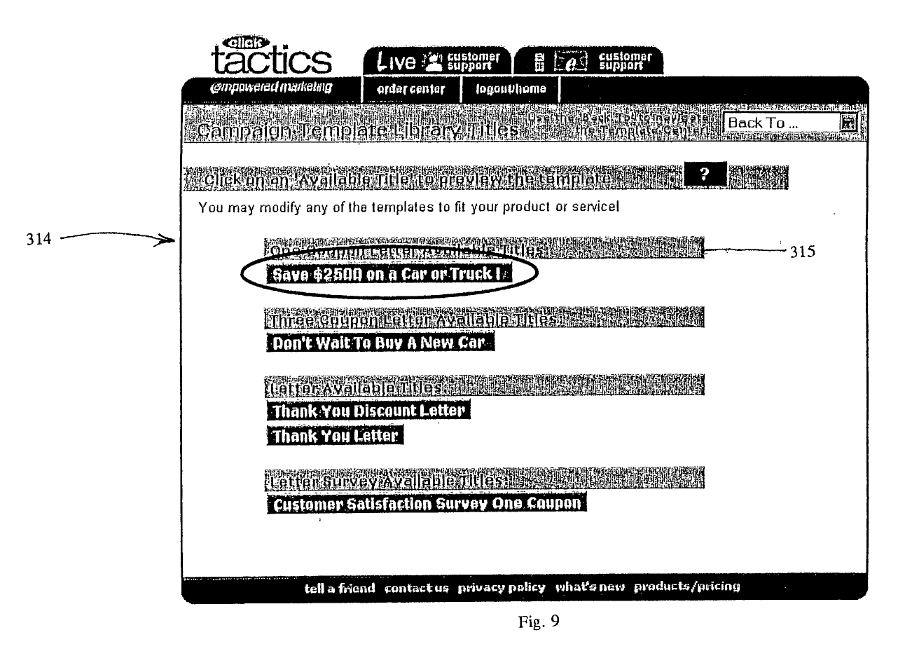

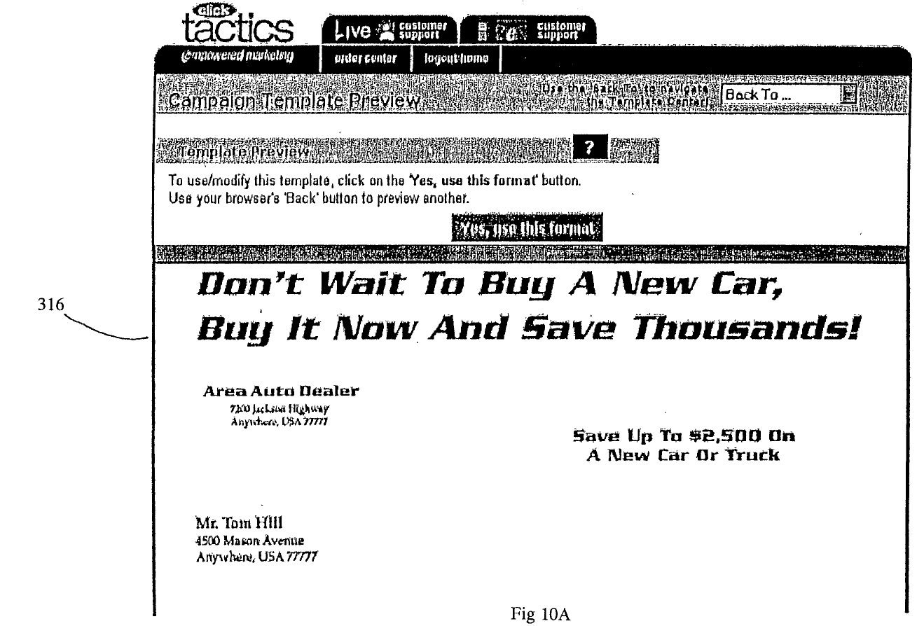

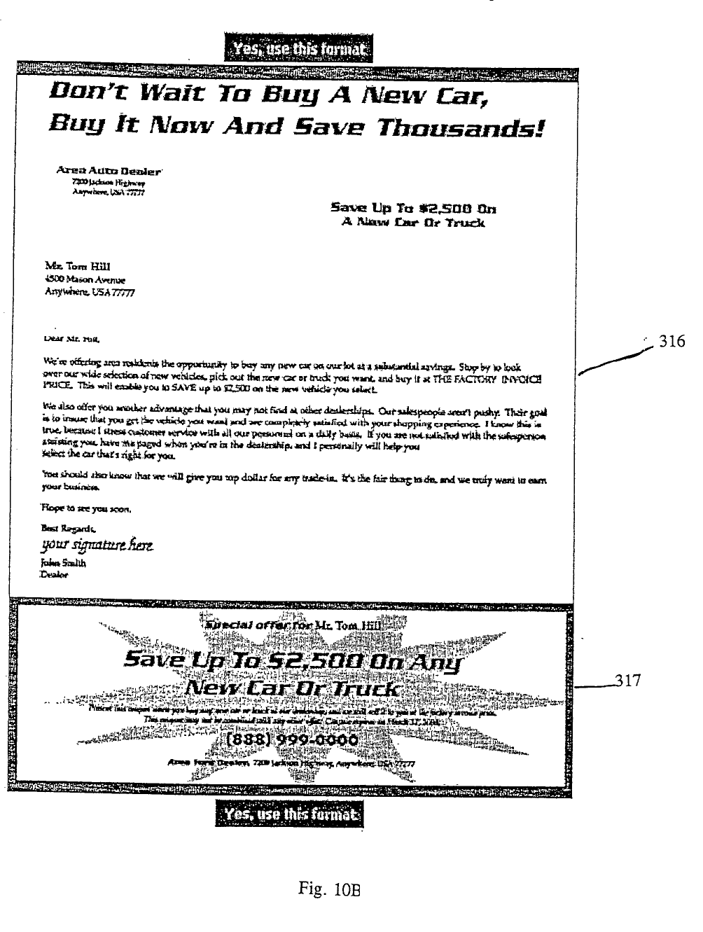

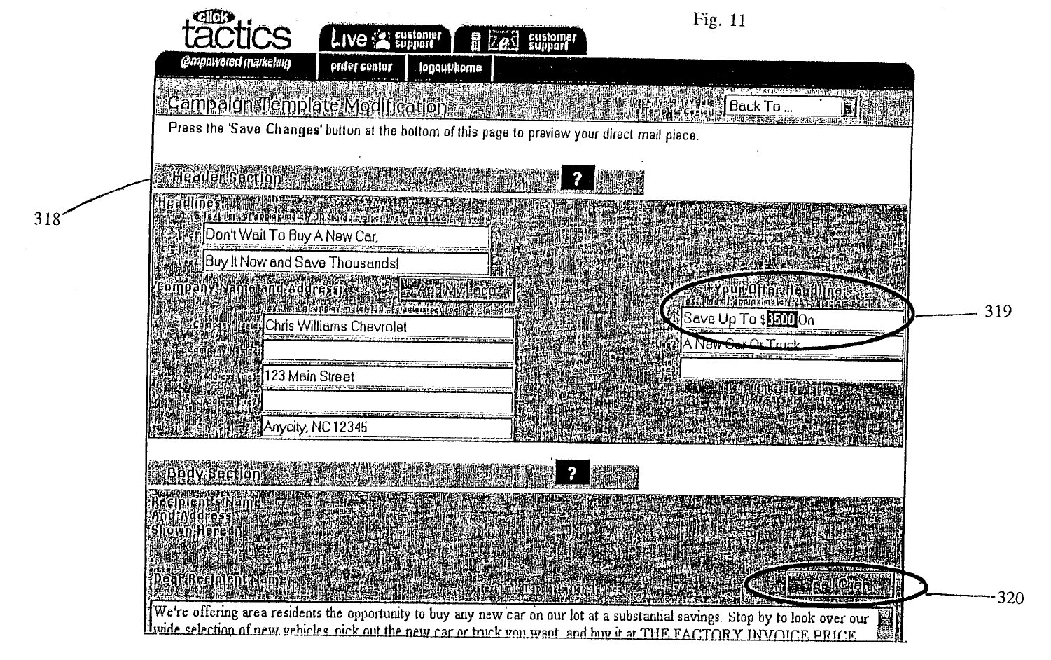

By clicking on prompt 313, web page 314 is accessed, as shown in FIG. 9. In this example, the client chooses a template entitled “One Coupon Letter Available Titles” (prompt 315) from a choice of several different templates. FIGS. 10A and 10B show illustrations of the selected template 316, which includes a template coupon 317. At this stage, the client can use the template “as is” or modify the template.

As shown on campaign template modification web page 318 in FIG. 11, the client has chosen to modify the selected template. In a preferred embodiment, the template is broken into several different sections to allow the client to walk through the different sections of the document through the web browser. Each section can be defined by one or more areas. In this example, the client has modified the discount from $2500 to $3500, in prompt 319, which corresponds to a particular section of the template. Alternatively, the sections of the template can be keyed to the client's graphic interface (e.g., mouse) so that the client can point to the particular section to be modified, as would be apparent to one of ordinary skill in the art given the present description. Other sections (and areas) of the template, such as the header, body, and salutation can be modified as well. In addition, other physical formatting characteristics, such as stock color, highlight color, font, etc. (which are utilized during fulfillment by the printer service) can also be modified by the client.

Preferably, the client facility provides an underlying XML document that reflects all client-input modifications of the template when the client completes this stage of the process. After completing the desired modifications, the client can perform a spell check of the modified template by selecting prompt 320.

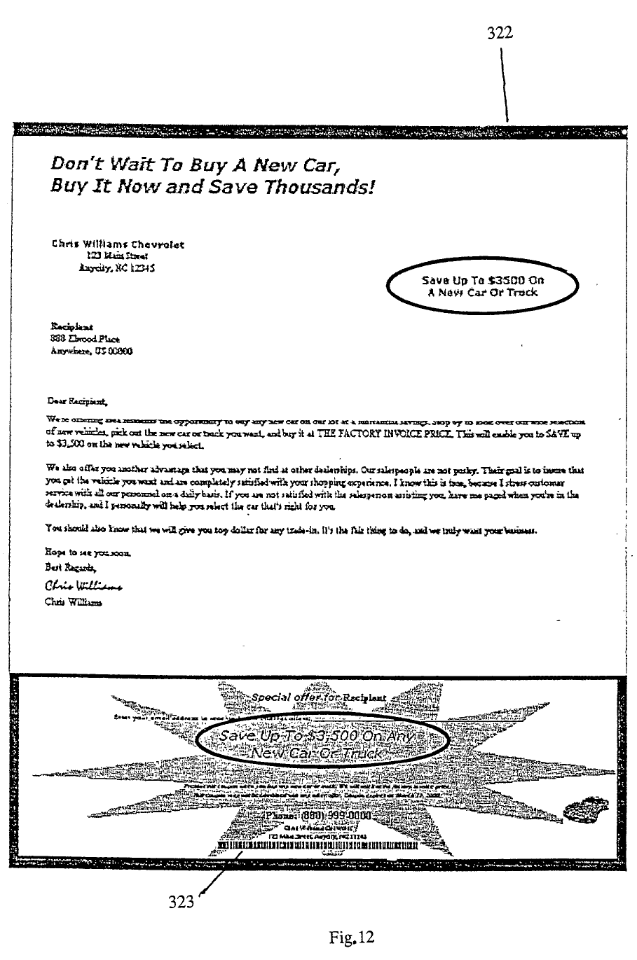

FIG. 12 shows an example of the modified template 322, including the barcode 323, which will be utilized for response tracking analysis.

At the central facility, for example, this client-entered information can be processed as follows. Preferably, an XML document based template can be formed based on the predefined document layout specification and client-entered information. The selected template will be pulled from either a main library of templates or the client's private library of templates stored at the central facility. The client's information will be merged into the XML document-based template and a new, customized XML document will be written. In a preferred embodiment, the new XML document can be formatted/translated correctly for the fulfillment services facility to use during printing. The translation may result in a file, or set of files, of a variety of formats/contents, depending on the fulfillment services facility preferences (e.g., Postscript, XML, etc.) and characteristics. This XML document file can also be named the same as the job number. Eventually, this XML file will be sent to the same queue as the customer address list, described below. Thus, according to the above process, the underlying XML model document is structured to provide an accurate version of the template, based on the printing characteristics of the printer that will be used to physically print the advertising piece. In this manner, the client will always view an accurate depiction of the final printed document, in terms of document format, font, color, and other characteristics.

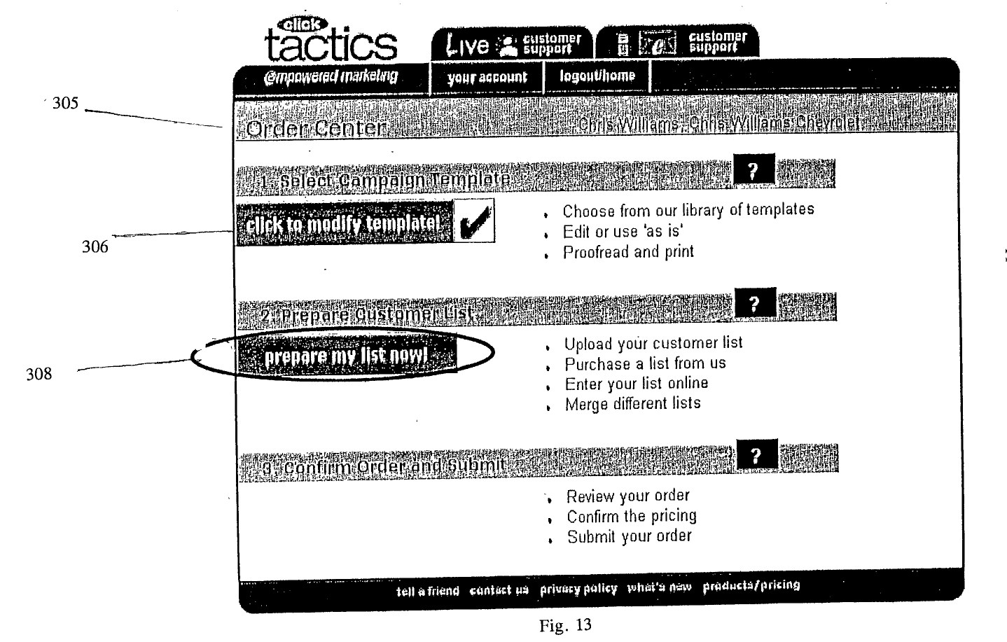

After selecting the appropriate advertising/promotions piece, the client can return to web page 305, as shown in FIG. 13, except that prompt 306 now indicates that the campaign template has been modified. At this point, the client selects prompt 308 to prepare the customer list.

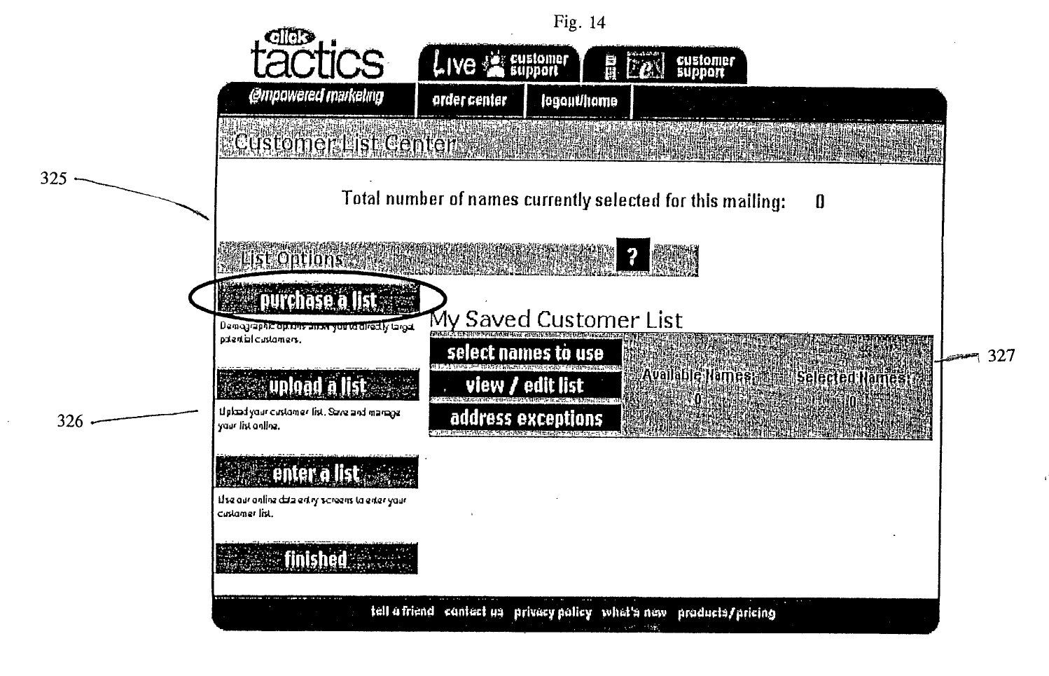

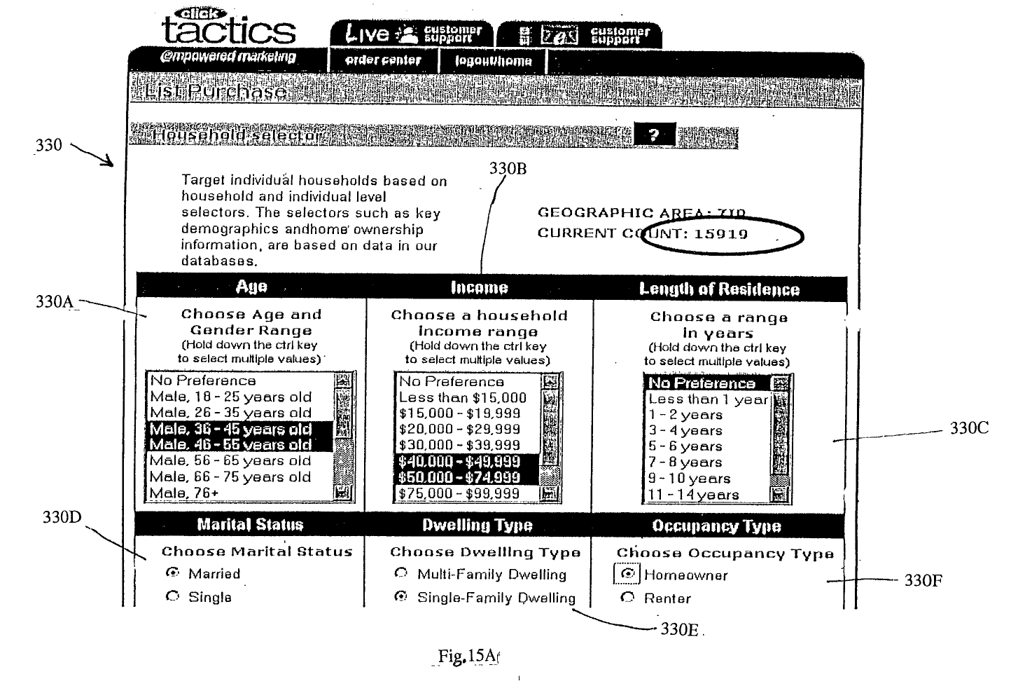

FIG. 14 shows customer list center page 325, which presents the client with several list options 326 and information 327 relating to the saved customer list. In this example, the client can purchase a list, upload a customer list from a private client library, or enter a list via the web site. As shown in FIG. 14, the client selects to purchase a customer list. In one preferred aspect of the present invention, the purchased customer lists can be provided by a third customer list provider that is linked to the central facility. Alternatively, the central facility can maintain an updated set of internal customer lists.

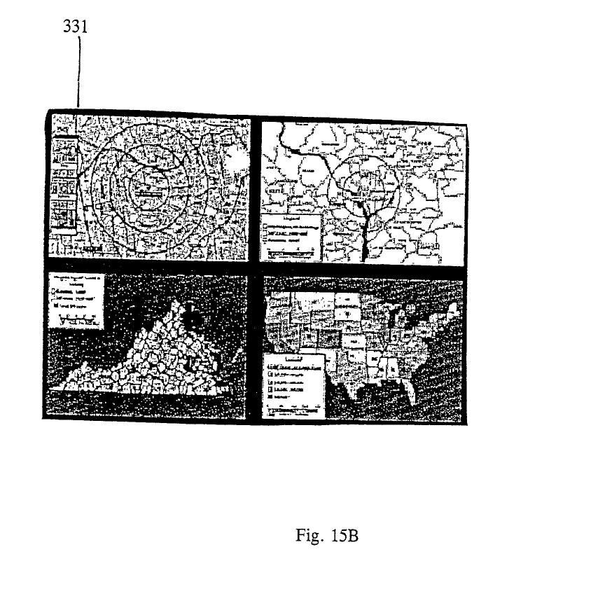

FIG. 15A shows an example list purchase web page 330. According to a preferred embodiment, the client can purchase a customer list based on key demographic characteristics, such as age, gender, length of residence, household income, occupancy type, marital status, dwelling type, and geographic area. For example, FIG. 15A shows several selection windows 330a-330f that allow the client to select desired customer characteristics. In addition, FIG. 15B shows several example windows in which the client can choose a particular geographic region from which to select customers for the direct mail campaign.

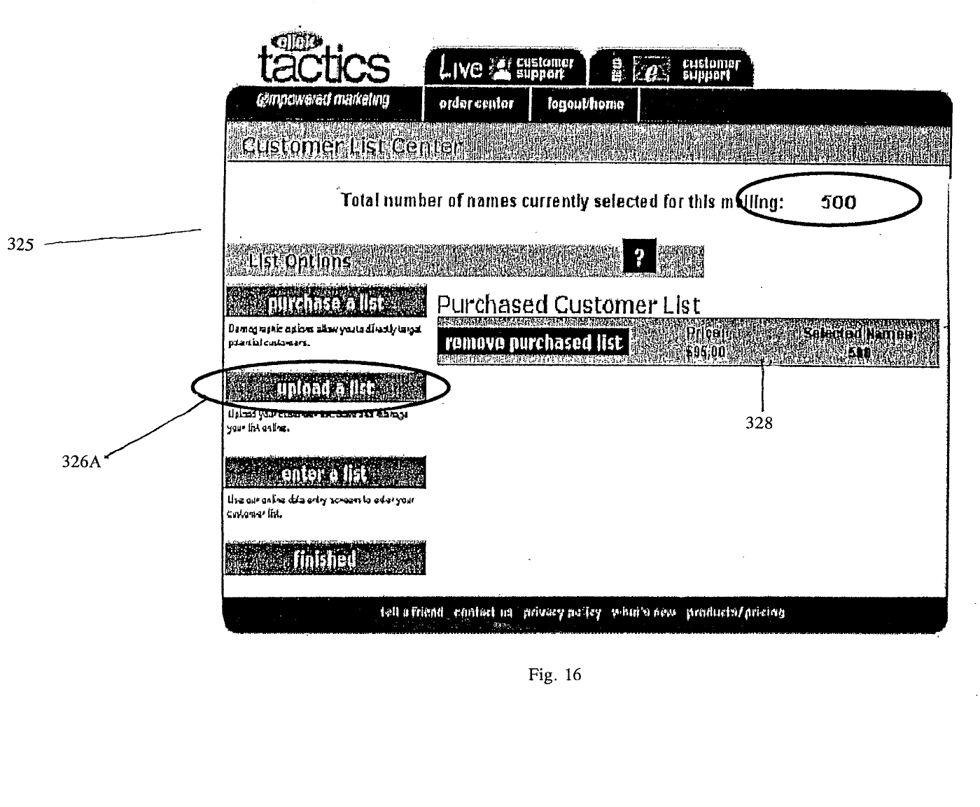

In this example, the client has chosen to purchase a customer list containing 500 names. In FIG. 16, the client revisits web page 325, which has been automatically updated to reflect the client's current selection, such as shown in window 328. In this example, the client selects prompt 326a, which allows the client to upload a pre-existing customer list that is stored at the central facility in a private client customer list library.

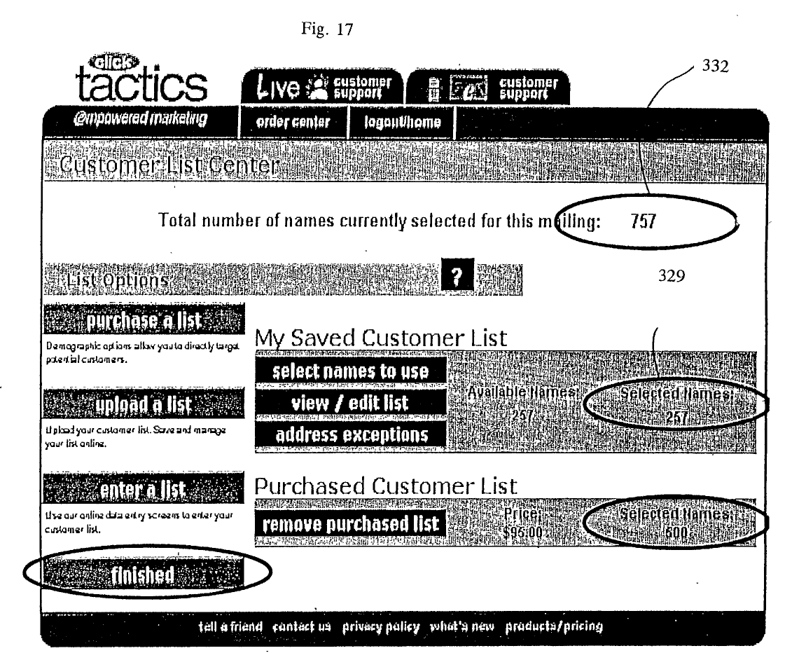

FIG. 17 shows an updated web page 325, which has been updated to include a window 329, which shows the characteristics of the client's previously saved customer list. The new total number of names selected is also automatically updated and displayed to the viewer in window 332. Other client selection options are also shown on web page 325, including the option to remove the purchased list, select particular names from the previously saved list, view and/or edit the previously used list, and mark address exceptions. In this example, the client is finished with the customer list and selects “finished.”

At the central facility, for example, this client entered information can be processed as follows. With respect to the address lists and coupon generation for results tracking analysis, an ASCII file can be generated with the job number at the top. Then the recipient's names and addresses, and other variable data, are written to the ASCII file in tab-delimited format. While each customer's information is written to the file, a coupon ID will be generated and written with each customer's address. This coupon ID can be sequential, beginning with the job number and ending in a number that will count up from a specified number. This identification scheme allows for internal tracking of coupons. Once the file is completely written, the file will be sent to a queue and wait there for an associated counterpart, in this example, the XML document, or other format, print version of the customized direct marketing piece.

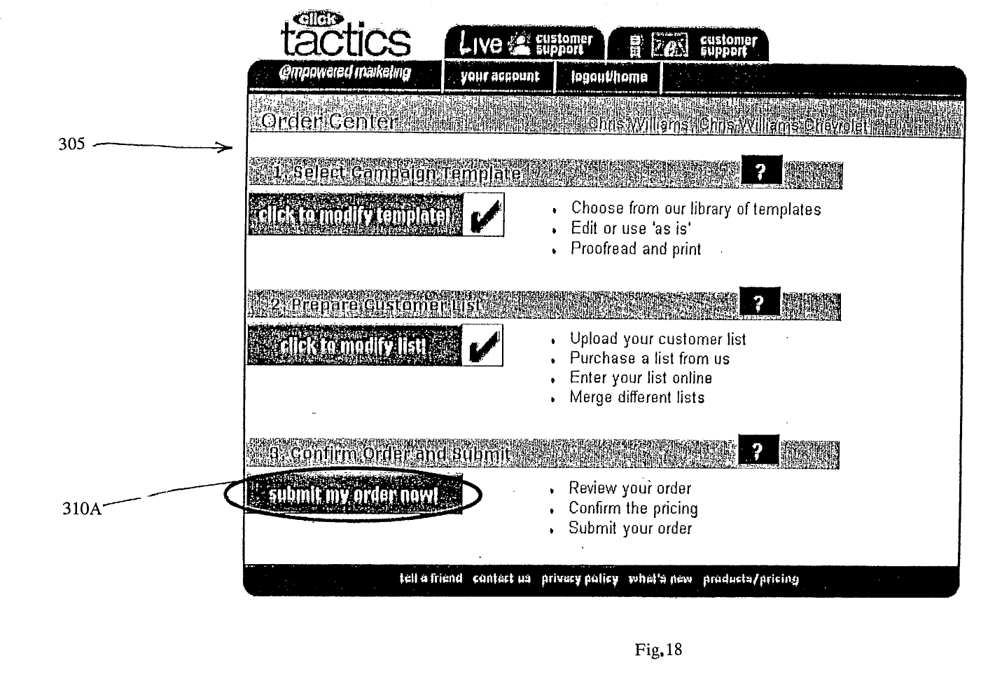

FIG. 18 shows that the client has returned to an updated order center web page 305, which shows that the client has selected a template and prepared a customer list. In this example, the client selects prompt 310a to submit the direct mail order.

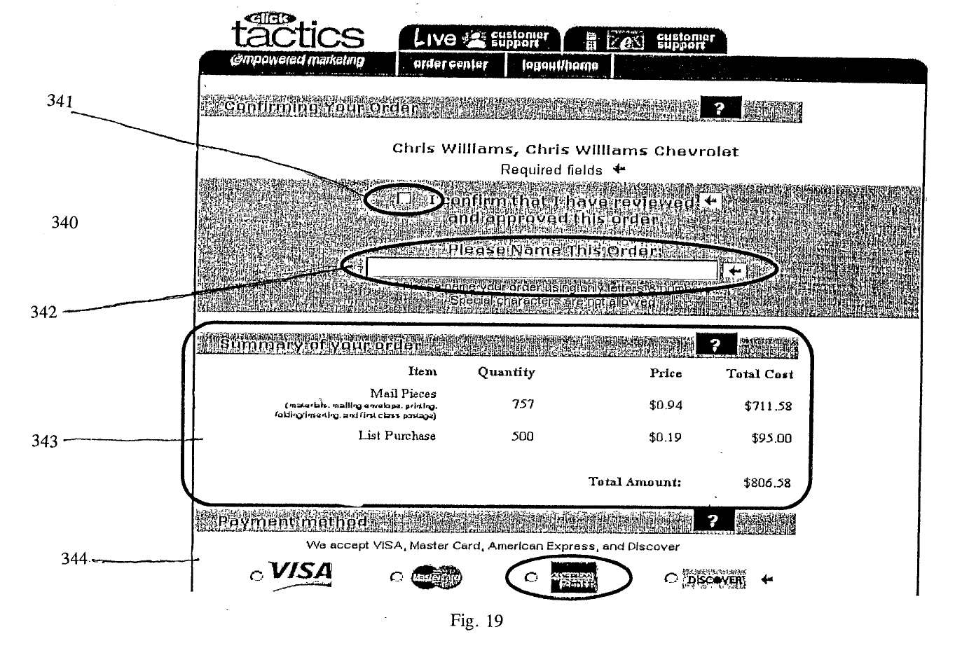

FIG. 19 shows an order confirmation page 340. This page allows the client to confirm the order, review the price, and provide further payment and client tracking information. For example, prompt 341 requests that the client signify that the order has been reviewed. Prompt 342 requests that the client enter a direct mail campaign name that can be used for response tracking analysis and billing purposes. Window 343 provides a summary of the oreder. Prompt 344 allows the client to select a particular payment method, such as by credit card. If the client already has an account with the central facility, that can be indicated in a further prompt (not shown) and the client can be billed using billing and accounting information stored in the database at the central facility.

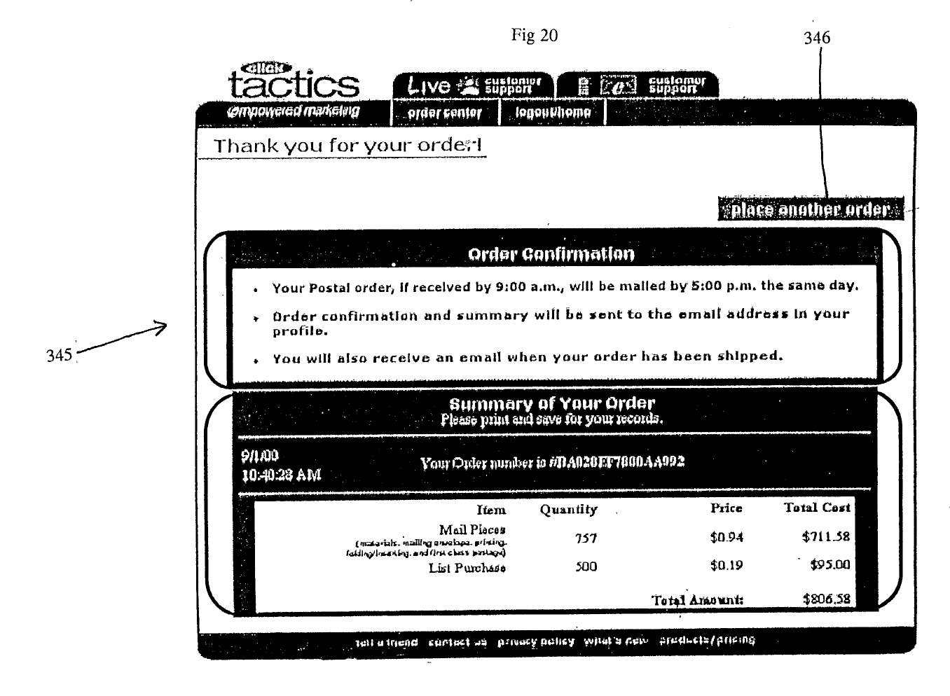

FIG. 20 shows a final confirmation page 345, which provides a price total and a summary of the order for the client to print and save. In addition, page 345 also can provide information concerning the shipping and confirmation schedule of the order. In addition, prompt 346 asks the client if an additional order is desired. If so, selecting prompt 346 will return the client to the order center page where a new direct mail campaign can be designed and ordered. Accordingly, the client can tailor a particular direct mail piece for a desired potential customer base.

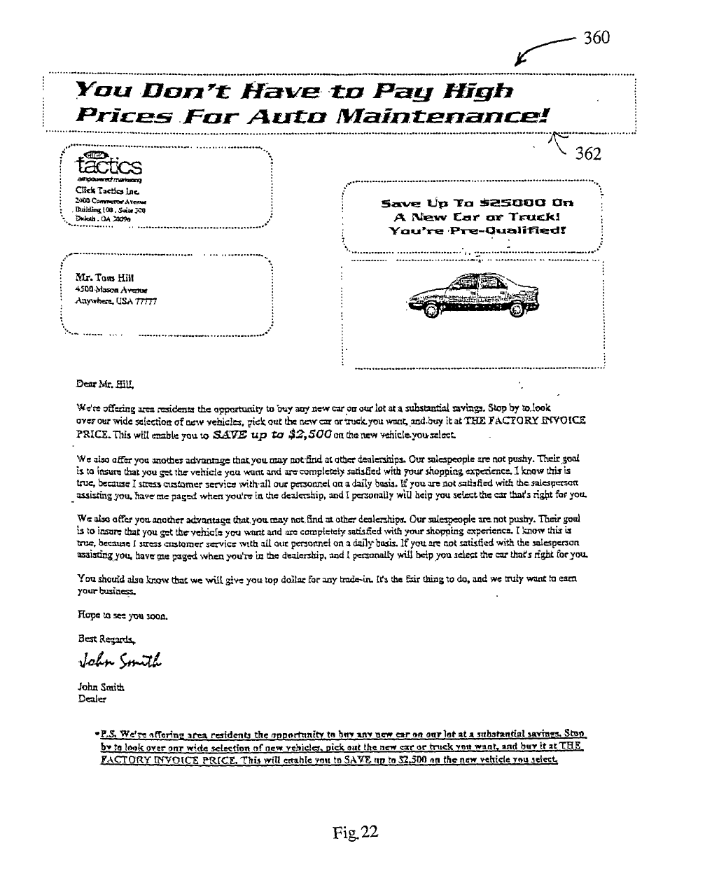

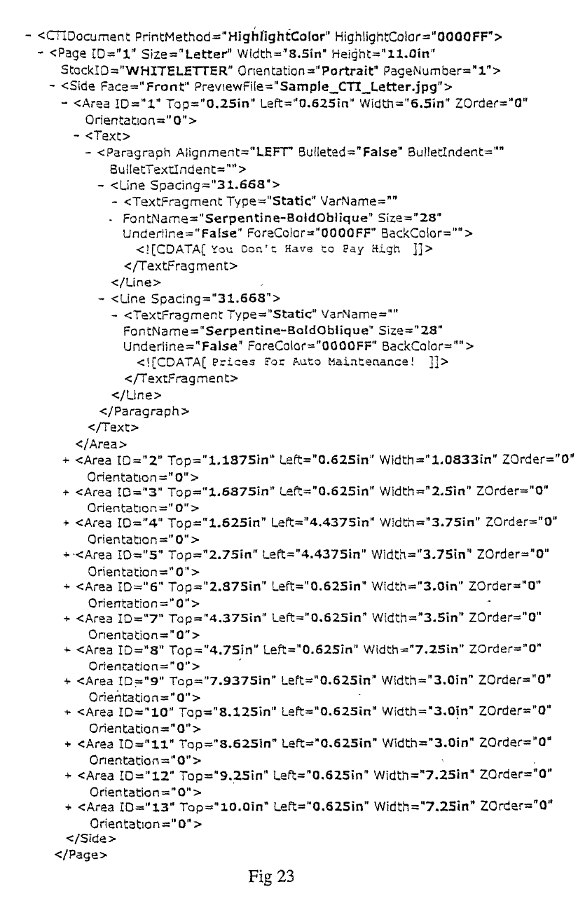

As discussed above, according to a preferred aspect of the present invention, the central facility runs against an underlying XML document that provides the definition of the targeted advertising piece. In this manner, it can be ensured that the client is viewing an accurate representation of what will be the final printed document. Examples of a direct mail piece and a Print Version XML document utilized to print the direct mail piece at the printer fulfillment center are shown in FIGS. 22 and 23, respectively.

FIG. 22 shows a template 360, which features an example advertisement for an automobile. The template can be apportioned into different portions in accordance with the underlying XML document. For example, the XML document can be broken into any number of Sections, each of which constitutes a ‘step’ in the document customization process. In each Section, there may be one or more defined Areas, which specify position and dimension of its content, either text or a graphic image. A Section can support multiple layout options or Choices (i.e. different sets of Areas), available to the user/client as an additional customization option. Additionally, the user/client can also have the choice of content within an Area, either graphic or text, as defined by the document template creator (some Areas may be defined as Text Only, others as Image Only or Either—in the latter case the user may choose which type of content). The document template creator can also provide pre-defined content within an Area, either defaulted text or graphics, and can in fact provide multiple Choices of content from which the user may choose. Finally, the document template creator may have elected to “Lock” the content of an Area, preventing the user from modifying the original contents. All of the above-mentioned options/choices and specifications are reflected in the underlying XML document.

For example, Area ‘height’ can be specified as variable, rather than a fixed height, to support variable length ‘paragraphs’. As a result, Areas may not only be positioned absolutely, with a defined top & left coordinate, but relative to other Areas, to allow for ‘floating’ Areas positioned relative to their variable height counterparts.

For Text content, the underlying template specifies all font characteristics, and the application controls the total amount of allowable content based on those font characteristics and the dimensions of the enclosing Area.

For Variable data, any Text content can contain references to variable data (recipient-specific information) that will be present within the final order's tab-delimited ASCII text file.

For Image or Graphic content, the application can proportionally scale down the image, as necessary, to fit the enclosing Area, thereby allowing for flexibility in image selection. Preferably, to preserve image quality, images will not be scaled up.

The XML document can also contain document-wide specifications and user choices, such as the choice of print stock and highlight color selection (for Highlight color output).

Concerning the Print Version, a translation from the customization-oriented XML document referenced above, to a printer-specific XML (or other format) document can be performed. This translation is essentially a paring down of the document to the essential print details. All Choices are eliminated, leaving only the selected Choice, all positioning is converted to absolute positioning for text and images, all text is positioned absolutely, line by line, with all font characteristics specified. For all Graphic Images contained within the document, the high resolution print versions are loaded, scaled, re-sampled and reformatted depending on output, and the file details, width and height are placed in the document. References to Variable data contained within the tab-delimited ASCII text file remain inline within the context of the document, for merging at the print fulfillment facility. An example of a Print Version XML document is shown in FIG. 23. In this example, “Area ID=1” corresponds to area 362 shown in FIG. 22. The Print Version XML document shown in FIG. 23 can be understood in accordance with the following example definitions and attributes:

1.0 Document: Defines the entire printed document and contains one to many Page Elements; Content=“eltOnly”

Attributes

PrintMethod: Required: True; Indicates the type of printing.

1—Black no color

2—Black and a Spot (Highlight) color.

3—DigitalColor (4 Color).

Values: “Black”, “HighlightColor”, “DigitalColor”

syntax: [PrintMethod=string]

HighlightColor: Required: True If PrintMethod=“HighlightColor”, Indicates the color used as the spot/highlight color. Must be one of the previously agreed upon spot colors available at the printer.

Value: Color expressed as a string formatted as “RRGGBB” with each color represented by a hexadecimal number (web format)

syntax: [HighlightColor=string]

Children: Page−minOccurs=“0” maxOccurs=“*” refer to section 2.0

Parents: [none]

2.0 Page: Defines a single page of the printed document; Content=“eltOnly”

Attributes

ID: Required: True; A unique number (within the CTIDocument) used to reference a specific Page.

Size: Required: True; Specifies the stock type.

Values: “Letter”, “Legal” and “UserDefined”

syntax: [Size=string]

Width: Required: True; Specifies the width of the Page.

Values: Values: inches with the following mask; “#.#in.”

syntax: [Width=string]

Height: Required: True; Specifies the height of the Page.

Values: inches with the following mask; “#.#in.”

syntax: [Height=string]

StockID: Required: True; Using a pre-defined identifier, StockID specifies the stock for printing, either regular or custom stock.

syntax: [StockID=string]

Orientation: Required: True when Size < > “UserDefined”); Specifies the paper orientation of all supported Size definitions. The only exception is when the size=“UserDefined”

Values: “Portrait”, “Landscape”

syntax: [Orientation=string]

PageNumber: Identifies the physical page number, used for sequencing of multi-page documents. Please note each page number corresponds to both sides of the page.

Values: “1 . . . +”

syntax: [PageNumber=int]

Children: Must contain either a <Front> or a <Back> element. See section 3.0.

Order=“seq”

Front: minOccurs=“0” maxOccurs=“1” refer to section 3.0

Back: minOccurs=“0” maxOccurs=“1” refer to section 4.0

Parents: CTIDocument: refer to section 3.0

3.0 Side: Contains all the areas for a side of the page.

Content=“eltOnly”

Attributes

Face: Required: True; Specifies the side of the page.

Values: “Front”, “Back”

PreviewFile: Required: True; Specifies the preview file for the specified side of the page. Supported preview files are jpg, pdf and html.

Values: filename.extension

syntax: [PreviewFile=string]

Children: Area: minOccurs=“1” maxOccurs=“*” refer to section 5.0

Parents: Page: refer to section 2.0

4.0 {placeholder}

5.0 Area: Defines a rectangle on the page that contains a Text or Image or Table.

Content=“eltOnly”

Attributes

ID: Required: True; A unique number (within the Side element) used to reference a specific Area.

Top: Required: True if Absolute=“TRUE”, Specifies the y coordinate in inches from the top edge of the stock to the top of the defined area.

Values: inches with the following mask; “#.#in.”

syntax: [Top=string]

Left: Required: True; Specifies the distance x coordinate form the left edge of the paper.

Values: inches with the following mask; “#.#in.”

syntax: [Left=string]

Width: Required: True; Specifies the width of the area.

Values: inches with the following mask; “#.#in.”

syntax: [Width=string]

Zorder: Required: True; Specifies the zorder of the areas that overlap.

Values: 0+

syntax: [ZOrder=int]

Orientation: Required: True; Specifies the orientation of the area content.

Values: 0 to 360

syntax: [Orientation=int]

Children: Contains only one of the following:

Text: minOccurs=“0” maxOccurs=“1” refer to section 6.0

Image: minOccurs=“0” maxOccurs=“1” refer to section 9.0

Table: minOccurs=“0” maxOccurs=“1” refer to section 10.0

Parents: Side: refer to section 3.0

6.0 Text: Contains 1 to many Paragraphs.

Content=“eltOnly”

Attributes

[None]

Children: Paragraph: minOccurs=“1” maxOccurs=“*” refer to section 7.0

Parents: Area: refer to section 5.0

Table: refer to section 10.0

7.0 Paragraph: Defines the paragraph definitions for 1 to many TextFragments that are within a carriage return.

Content=“eltOnly”

Attributes

Alignment: Required: True; Specifies the horizontal alignment of the paragraph.

Values: “LEFT”, “CENTER”, “RIGHT”

syntax: [Alignment=string]

Bulleted: Required: True; Specifies if the paragraph is to contain a bullet.

Values: “TRUE”, “FALSE”

syntax: [Bulleted=boolean]

BulletIndent: Required: True if Bulleted=“true”, Specifies the x coordinate of the bullet from the left edge of the Area.

Values: inches with the following mask; “#.#in.”

syntax: [BulletIndex=string]

BulletTextIndent: Required: True if Bulleted=“true”, Specifies the x coordinate for the start of the text from the left edge of the Area.

Values: inches with the following mask; “#.#in.”

syntax: [BulletTextlndex=string]

Children: Line: minOccurs=“1” maxOccurs=“*” refer to section 8.0

Parents: Text: refer to section 6.0

8.0 Line: Defines the soft carriage return-defined lines in a paragraph.

Content=“eltOnly”

Attributes

Spacing: Required: True; Measured in Points (72 points/inch). Specifies the total vertical distance occupied by a line of text, from the top of the highest Font Bounding Box for the line to the next line's top of its' highest FontBBox.

Children: TextFragment: minOccurs=“1” maxOccurs=“*” refer to section 9.0

Parents: Paragraph: refer to section 6.0

9.0 TextFragment: Contains a series of words that are related by the attributes of the TextFragment attribute and does not contain a carriage return (see Paragraph section 6.0). All text of the element is of CData type. If the TextFragment is defined as variable the element will contain the sample text.

Content=“textOnly”

Attributes

Type: Required: True; Specifies the type of text fragment.

Values: “Static”, “Variable”

syntax: [Alignment=string]

VarName: Required: True If Type=“Variable”, Specifies the variable data tag name that will be contained in the variable data file.

Values: Predefined values setup with the printer.

syntax: [VarName =string]

FontName: Required: True; Specifies the name of the font used.

Values: Predefined values setup with the printer.

syntax: [Bulleted=string]

Size: Required: True; Specifies the font size of the specified FontName attribute.

Values: point sizes as integer.

syntax: [Size=integer]

UnderLine: Required: True; Specifies if the font is underlined.

Values: “TRUE”, “FALSE”

syntax: [UnderLine=boolean]

ForeColor: Required: True; Specifies the fore color of the font. Note: the following scenarios for the CTIDocument element:

Scenario 1—If the HighlightColor attribute of the CTIDocument is different from the ForeColor attribute of the TextFragment element and the PrintMethod attribute is equal to HighLightColor then default ForeColor to black (000000). Furthermore, always default the Forecolor to black (000000) when the PrintMethod is equal to “Black”.

Value: Color expressed as a string formatted as “RRGGBB” with each color represented by a hexadecimal number (web format)

syntax: [ForeColor=string]

BackColor: Required: False; Specifies the background color of the font. This is only valid if PrintMethod is equal to DigitalColor.

Value: Color expressed as a string formatted as “RRGGBB” with each color represented by a hexadecimal number (web format)

syntax: [ForeColor=string]

Children: [None]

Parents: Line: refer to section 7.0

10.0 Image: If the image is included with the print job then the Image element text contains the filename of the image. If the image is referenced to a stored image at the printer then the image element text is null. The image name contains the filename.extension.

Content=“textOnly”

Attributes

PrinterIndex: Required: True If image is referenced and stored at the printer; Specifies the printer index identifier predefined with the printer.

syntax: [PrinterIndex=string]

Width: Required: True; Specifies the width of the image.

Values: inches with the following mask; “#.#in.”

syntax: [Width=string]

Height; Required: True; Specifies the height of the image.

Values: inches with the following mask; “#.#in.”

syntax: [Height=string]

ColorOverride: Required: False; Specifies the color scale of the image. This is only valid when PrintMethod < > “Black”.

Value: Color expressed as a string formatted as “RRGGBB” with each color represented by a hexadecimal number (web format)

syntax: [ForeColor=string]

Children: [None]

Parents: Area: refer to section 5.0

In addition to the above definitions and attributes, the term “content” specifies type of element content allowed, where content=“textOnly” is defined such that the element can contain only text and attributes, not elements; content=“eltOnly” is defined such that the element can contain only other elements and attributes, but not free text; content=“empty” is defined such that the element cannot contain text or elements; and content=“mixed” is defined such that the element can contain a mix of named elements and text. This is the default value. When elements and text are mixed together, elements must not be between portions of the text. It is also preferable to set all elements together followed by the data for the element.

The aforementioned process can be utilized in conjunction with the fulfillment process in the following manner. After the client has completed ordering, the central facility will prepare an order package for fulfillment that includes the client entered information in a data form that can be processed by the fulfillment service facility.

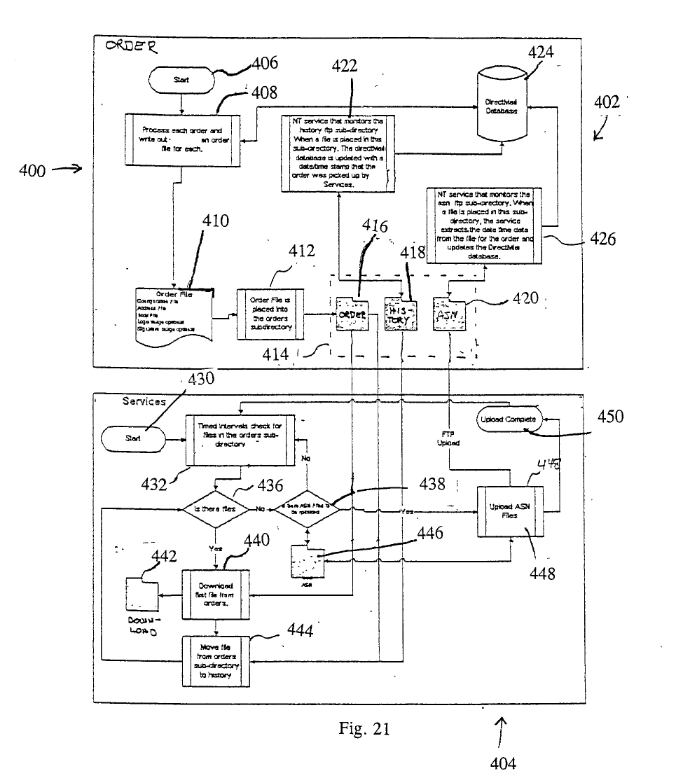

In conjunction with the on-line generation of a desired targeted advertising and/or promotional campaign, according to a preferred aspect of the present invention, the central facility can be linked with a service, such as a printing service, to fulfill a client's order, in a client-server configuration. An example 400 of the communications process between the central facility 402, which processes the client's order, and the services facility 404, which fulfills the order, is shown in FIG. 21.

An order is placed at start step 406. The central facility processes the order and writes out an order file at step 408. The order file 410 can include numerous information about the particular order, including a configuration file, an address file, a body file, an image file, an automatic signature file (for the particular client), and the like.

In one example, the order file layout can include the following:

(1) Address File: The file is to be named [ordernumber].dbf. The file format is an ASCII file quoted and tab delimited. The file can contain the following columns: CouponID; Salutation; First Name; Last Name; Address 1; Address 2; City; State; and Zip and other variable data, on a recipient-by-recipient basis. The columns are referenced within the Document definition file for recipient-by-recipient merging into the content of the document at the print facility.

(2) Document definition file: The file is to be named [ordernumber].extension. The file extension can vary, depending on the particular print fulfillment center's preference. For example, it may be a print-version XML document, which would be named [ordernumber].xml, or a postscript file, named [ordernumber].ps, or other formats. The file content is ASCII text, which contains the body of the advertising piece, if needed.

(3) Images: Any images referenced in the Document definition file will be included in the order, named [imageidentifler]_n.tif, where n is the instance of a particular image in the order.

Other order file layouts can also be utilized as would be apparent to one of ordinary skill in the art given the present description.

In step 412, the order file is placed in the orders subdirectory 416, which can be part of an orders database 414 at the central facility 402. For example, this order subdirectory can be part of a secure FTP site.

At the services facility 404, the order fulfillment process is started at step 430. As shown in step 432, timed intervals can be used to check for files in the orders subdirectory at the central facility. For example, after a client places an order, the system shown in FIG. 21 can wait for 90 minutes (or other appropriate time), to allow the client to change/modify the order.

In step 436 it is determined whether any files exist in the orders subdirectory. If the determination is yes, then in step 440, a first file is downloaded from the central facility into the download file 442 at the services facility 404. The first file can contain one or more particular orders. Also, the downloading can be implemented using a secure socket layer (SSL) FTP client-server configuration. In addition, the services facility can unzip/unpackage the first file and use the data to start printing. For example, the services facility can take the direct mail piece in postscript form and use the variable data to print out as many direct mail pieces as there are addresses in the associated customer list (e.g., ASCII) file.

In step 444, the first file is moved from the orders subdirectory 416 to the history subdirectory 418 at the central facility 402.

If the determination in step 436 is no, then it is determined in step 438 whether there is an ASN (an advanced shipping notification that contains the status and shipping information for placed orders) file to be uploaded. If the determination from step 438 is no, then the process returns to step 432. If the determination in step 438 is yes, at step 448, the ASN file is uploaded to the subdirectory 420 at the central facility. Also, the uploaded ASN file is placed in a local ASN subdirectory 446 at the services facility 404.

For example, the FTP subdirectory structure (order, history, and ASN) can have the following characteristics and structure:

<ROOT>

/orders: order files for download will be located;

/asn: ASN files uploaded to this location; and

/history: after an order file is downloaded (the file should be moved out of the orders subdirectory into this location.

In another example, the ASN file can have the following layout and characteristics. The ASN file can be named [mmddyyhhmm].asn. The file format can be file tab delimited. The file can be uploaded at the same time the printer checks for the orders. The file can be a log containing all order status information for orders processed to that point. The file can also contain the following columns: ORDERID; STATUSID; VALID VALUES (05-order printed; 06-order shipped; 11-cancelled before print; and 12-cancelled after print); DATETIME STAMP; QTY (where the quantity field can be provided on status 05); and CANCELLATION NUMBER (which can be provided on status 11 or 12). Other ASN file layouts and FTP structures can also be utilized as would be apparent to one of ordinary skill in the art given the present description.

In step 426, an NT service at the central facility monitors the subdirectory 420. When a file is placed in subdirectory 420, the service extracts the date time data from the file for the order and updates the direct mail database 424. In addition, in step 422, the NT service monitors the history subdirectory 418. When a file is placed in this subdirectory, the direct mail database 424 is updated with a date time stamp that the order was picked up by the services facility. At step 450, the upload is complete. Once the upload is complete, the fulfillment center can physically generate the order (e.g., by printing the desired direct mail letters/coupons/postcards). In addition, the central facility is notified that the order has been picked up and the direct mail database is updated accordingly.

For example, the aforementioned NT service can monitor the job holding queue and when a job number/time stamp is sent to the queue, the service facility will pull each record from the database containing the name and the addresses of customers from the client's list.

To implement this fulfillment process, for example, the services facility can convert the downloaded files and extract variable data from the ASCII flat files to the service facility's database (not shown). The finished printed material (e.g. direct mail piece) can then be sent to the intended customers. Other processes can be utilized to fulfill orders, as would be apparent to one of ordinary skill in the art given the present description.

As mentioned previously, according to a preferred aspect of the present invention, during the generation of the target advertising and/or promotional material, a response tracking analysis capability is provided with the target advertising and/or promotional material in order to allow the client to receive continually updated response analysis of the advertising campaign. In a preferred aspect, the target advertising and/or promotional material is provided with a barcode or machine readable mark that contains client/customer/product information utilized to evaluate the effectiveness of the advertising and/or promotional campaign. For example, the barcode can be detected at a client site using a conventional barcode scanning device. In addition, the data retrieved from the scanned barcode can be stored in a personal computer or memory of the barcode scanner. This response tracking information is then synchronized with the client's database at the central facility when the client's computer or scanning device is linked to the central facility. In this manner, the appropriate tables within the client facility are updated with the response tracking information. Preferably, this response tracking information is provided with one or more of the following ties: (1) ties to the order; (2) ties to the coupon; (3) ties to the client that the retailer came through (e.g., if a parent corporation is a client that gave permission to a franchisee/retailer to provide the particular coupon); (4) ties to the recipient of the coupon; (5) ties to the client/retailer that ordered the coupon. In addition, it is preferred to structure an index number to reduce the actual ID number that is provided for each coupon, so that a client or retailer with access to the central facility database can read the index number. For example, the index can be a 18n character code with two characters that identify the printer/manufacturer. This scheme also allows the central facility to utilize more than one particular printer for a particular order, if necessary.

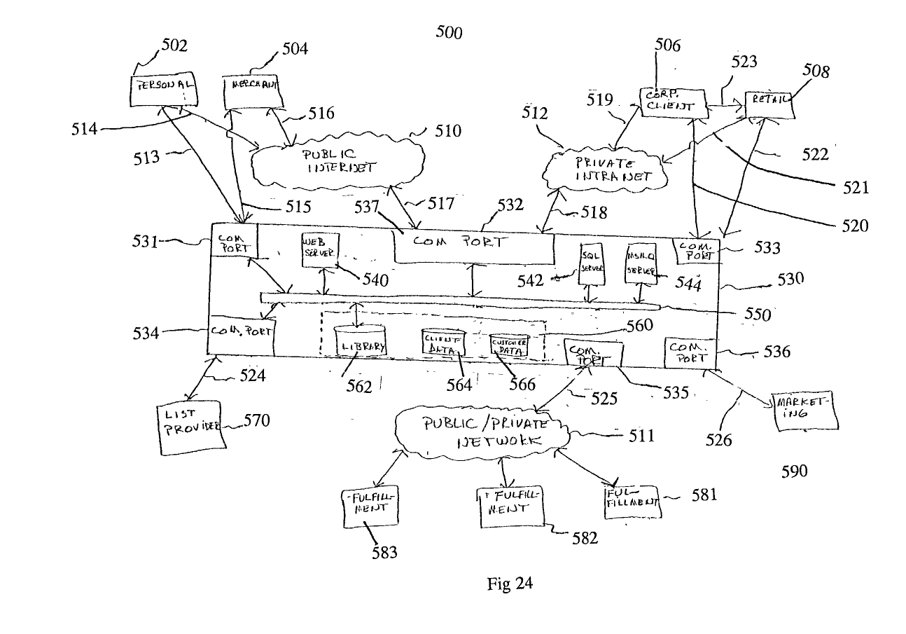

According to another embodiment of the present invention, a system is provided which can implement the aforementioned processes or variations of those processes. With reference to FIG. 24, an on-line service, such as the internet, is described. Alternatively, other dial-up, private intranet, or other known types of electronic communications can be utilized. In addition, where the preferred aspect of this embodiment relates to a single internet URL (uniform resource locator) on the world wide web (WWW), it is understood that several URLs can be utilized, including at least one mirror site to provide backup to the parent site. The mirror site can replicate the parent site and mirror all parent site transactions in order to improve the availability of the parent site during periods of high volume, or other conditions, such as power outages, etc.

FIG. 24 shows a system 500 according to an embodiment of the invention. The system 500 includes an electronic communications system, such as an on-line or Internet-based service. In a preferred embodiment, the aforementioned advertising and/or promotional services are offered to users through public Internet 510 or private intranet 512. For example, a personal user client 502 can communicate to central facility 530 via dial-up (public internet) 514, 517 or direct dial line 513. Alternatively, the user can be a merchant 504 that communicates to central facility 530 via dial-up (public internet) 516, 517 or direct dial line 515. In another aspect of system 500, the user can be a corporate client 506 that communicates to central facility 530 via the internet (lines not shown), private intranet 519, 518, or direct dial line 520. In addition, the user can be a retailer 508 associated with the corporate client 506 that communicates to central facility 530 via internet (not shown), private intranet 521, 518, direct dial line 522, or through the associated corporate client. ISPs and CSPs (commercial service providers) are also contemplated in the above communication schemes.

The central facility web site communicates to the various communications lines via communication ports, such as corn ports 531, 537, and 533. The central facility also includes a primary domain controller, or web server 540 to interface through bus 550 with the browser software of clients accessing the URL and to deliver the individual browser commanded web sites. In addition, the central facility 530 can include a main database 560 to provide, among other things, list management and response tracking capabilities. Database 560 can include one or more libraries (signified by library database 562), a client database 564, and a customer database 566. The main database 560 can store a wide variety of accounting, client, customer, list, response analysis, template, and other information. The main database 560 will be described in greater detail below.

In addition, client facility 530 can include an application server (shown as SQL server 542) to handle application operations exchanged through the bus 550 between the browser software and the main database 560. A message query server 544 can also be included.

For example, with respect to the hardware, the central facility can employ the following types of commercially available servers: Compaq Proliant 5500R web servers configured with processors, RAM, mirrored drives, and a Microsoft Site Server; Compaq Proliant 1600R FTP servers and a Certificate server (with associated hardware); a Compaq Proliant 1600R SQL server (with associated hardware); and clustered Compaq Proliant 7000 database servers (configured with appropriate hardware). Other physical implementations will become apparent to those of ordinary skill in the art given the present description.

The system 500 can also include a corn port 534 that provides communication from the central facility 530 to a customer list provider service 570 via line 524. In addition, a corn port 535 can be included to provide communications either directly or through a public and/or private communications network 511 to a fulfillment center, such as fulfillment centers 581, 582, and 583. As mentioned above, the fulfillment center can be used to print or manufacture the desired targeted advertising and/or promotional campaign materials. Further, central facility 530 can be linked to a marketing analysis center 590 which can further evaluate and perform additional marketing analysis using the updated response tracking data stored at the central facility.

Preferably, a web site operating system software can be Microsoft® Windows NT®-based. The web server operations can be controlled by the Primary Domain Controller, using a Microsoft Internet Information Server (ISS) software, such as version 4.0, or the like, which is integrated with the Windows NT Directory Services, to provide an integrated platform that makes the Internet an integral part of the operating system. In addition, as mentioned previously, various XML documents can be utilized to optimize the ability of the system in providing clients with accurate and reliable representations of the targeted advertising and/or promotional materials being generated within.

Preferably, the main database 560 is a relational database that is SQL structured to provide simultaneous access to thousands of users, if needed. The database management system (DBMS) software, i.e., the collection of commands and programs that provide the entering, storing, organizing and data retrieval capabilities of the database, can be a Microsoft SQL Server software, e.g., version 7.0, or the like, which is installed on the applications server 542. SQL provides the base language (syntax and idioms) used to query relational databases in a standardized, cross/platform/product manner through an open database connectivity (ODBC) access standard.

For example, Microsoft transaction Server software can be installed in server 542 to function as an ODBC, thereby providing the ability to access data from any application, regardless of the DBMS utilized. In this example, a middle layer database driver can be inserted between the application and the DBMS, which translates applications data queries into commands understood by the DBMS.

In addition, the central facility 530 can employ a layered security approach, such as with a secure sockets layer (SSL) for communications technique. This technique can be supplemented with a 128 bit DES or greater encryption of sensitive data while in transit between clients/retailers and while residing in the database. Additional technologies such as firewalls, authentication and authorization can be used to prevent breaches in unauthorized access to the central facility 530. In addition, the application services can be detached and protected from the web site itself by placement in remote, protected servers.

The languages utilized can be Active Server Pages (ASP), Visual Basic (VB), Visual C++, JavaScript, VB Script, HTML, XML, Perl, and other conventional languages.

The targeted advertising and/or promotional service materials, documents, and the like, can be stored in the main database 560.

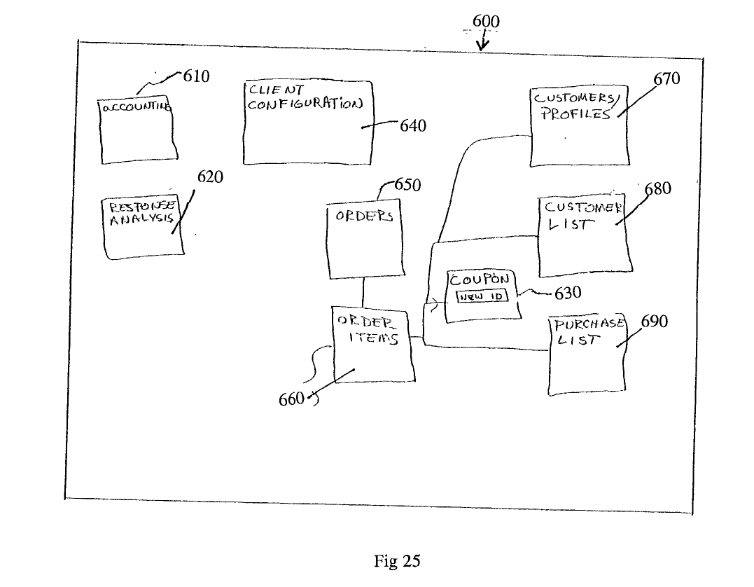

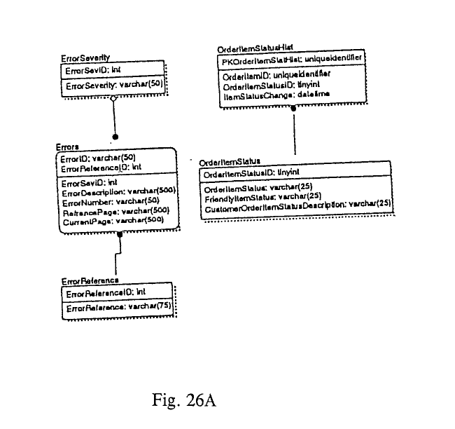

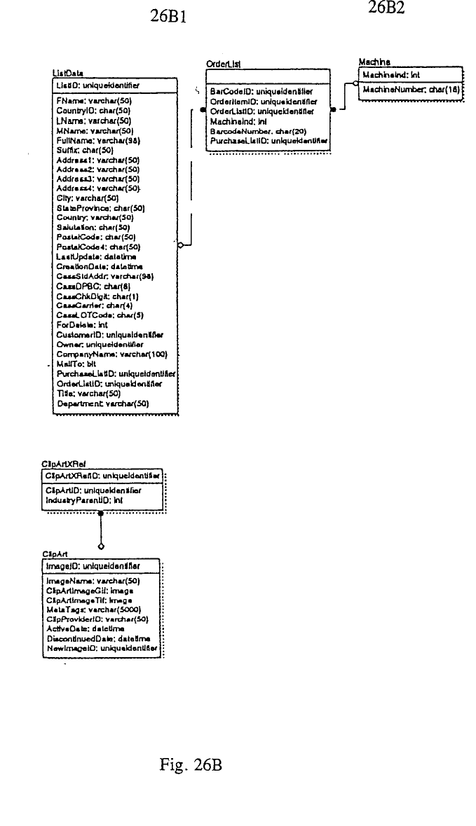

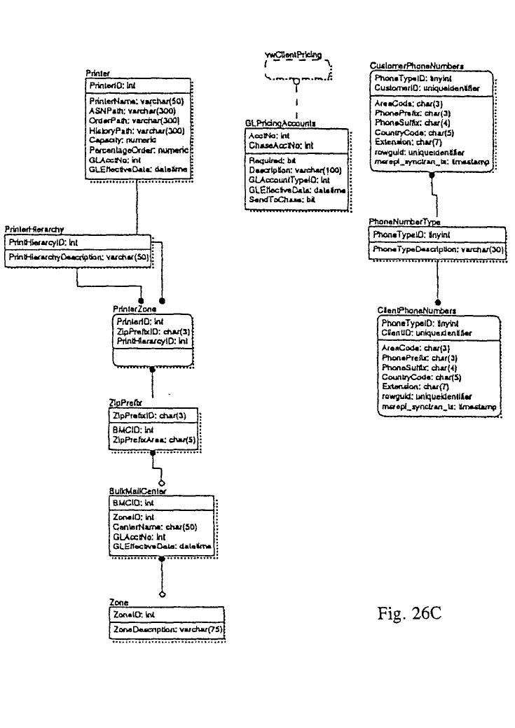

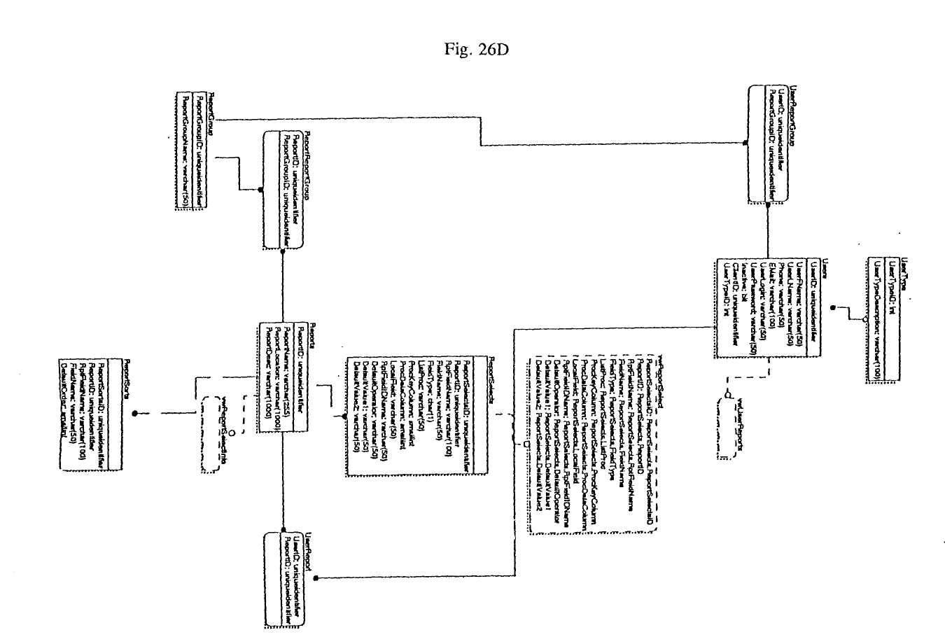

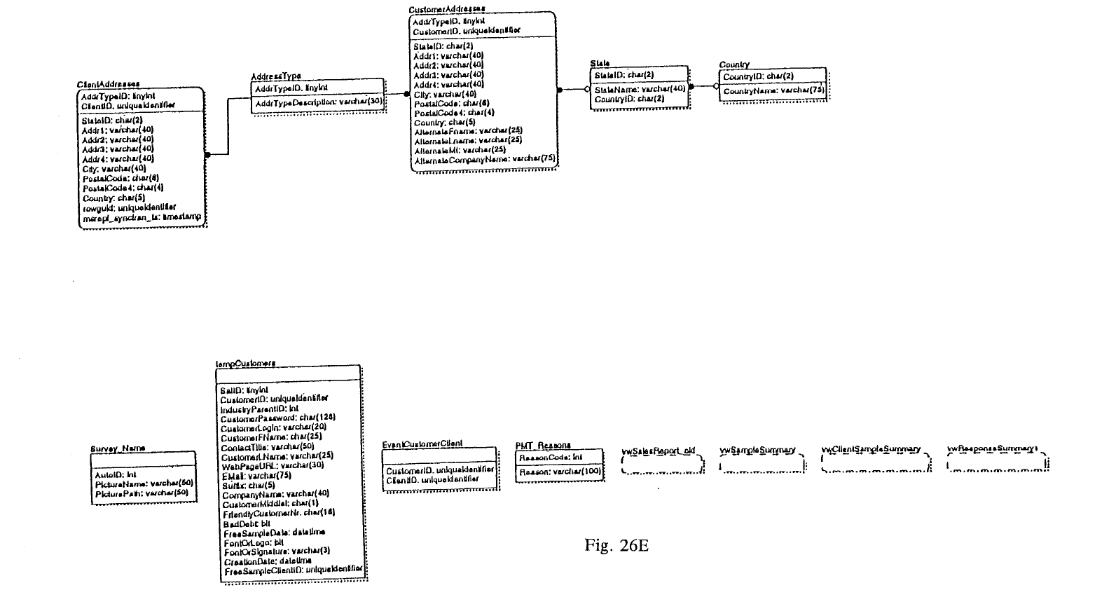

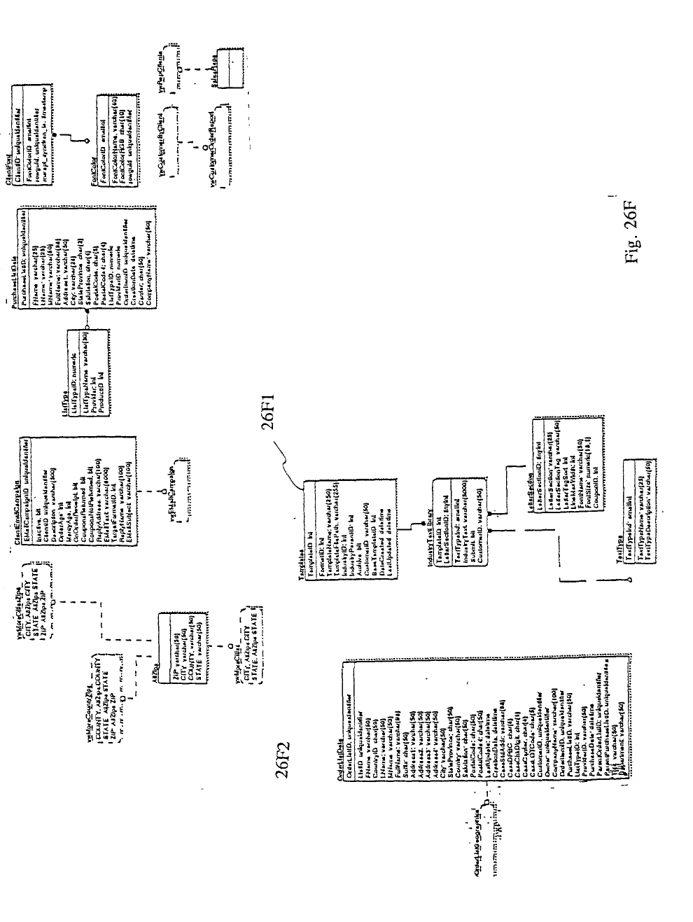

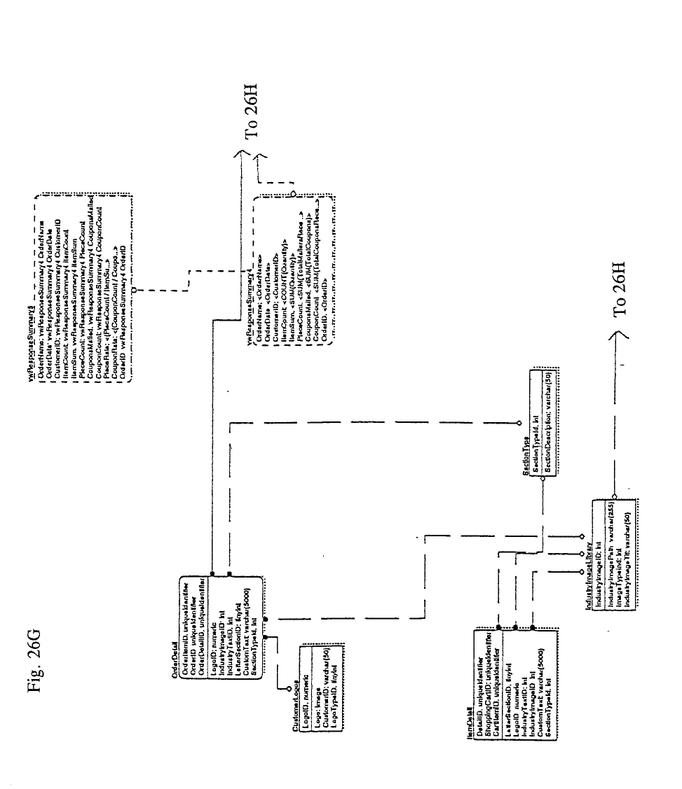

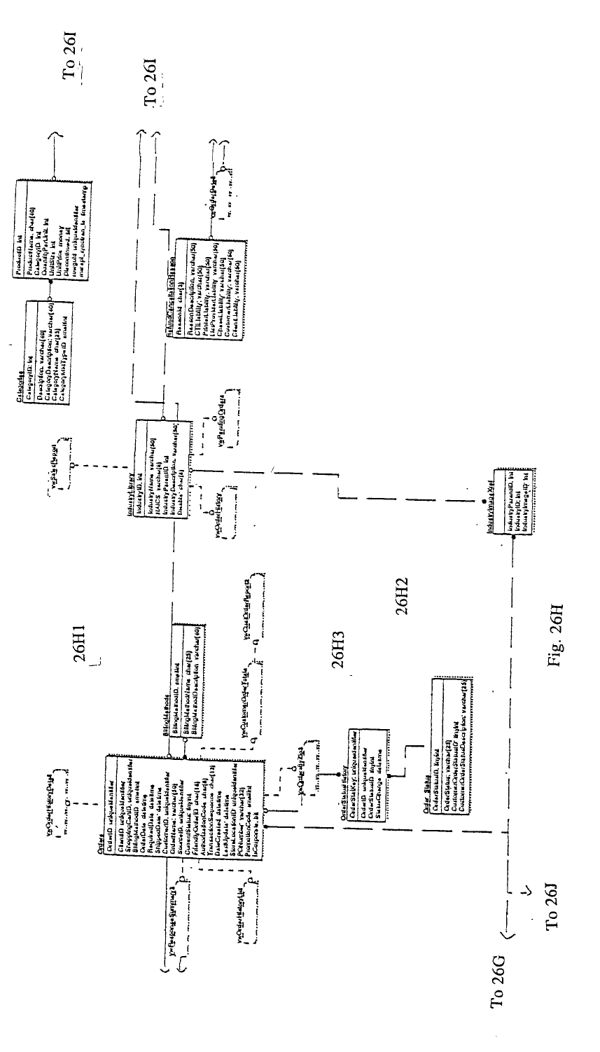

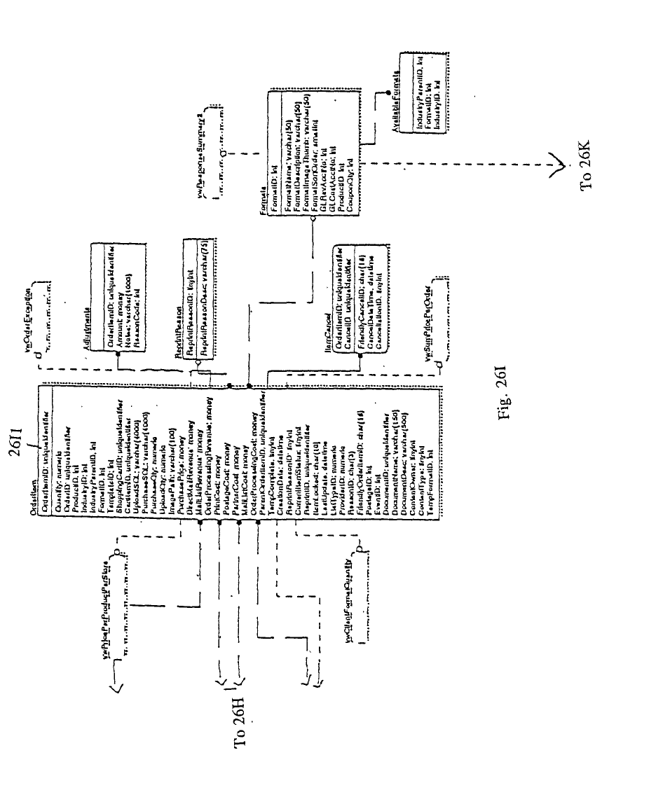

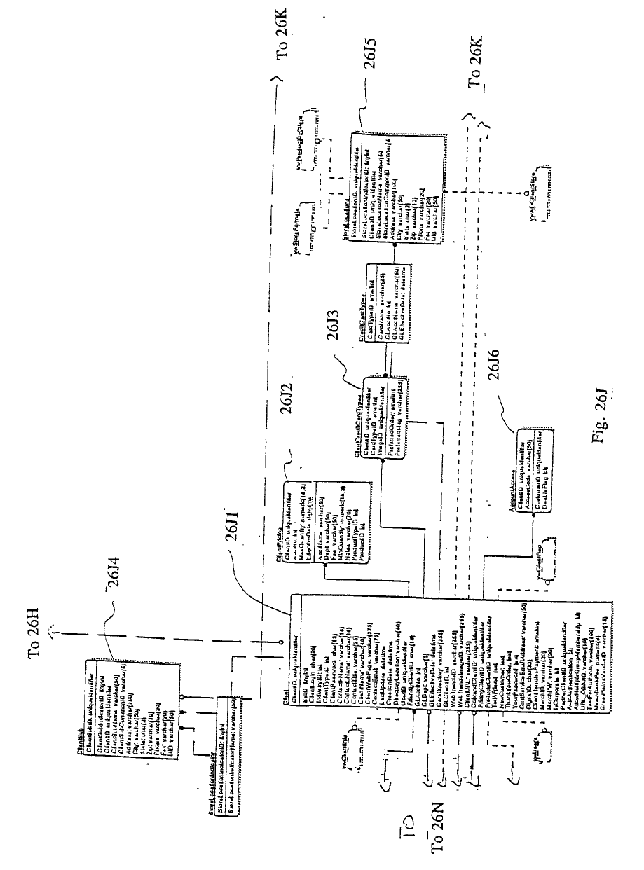

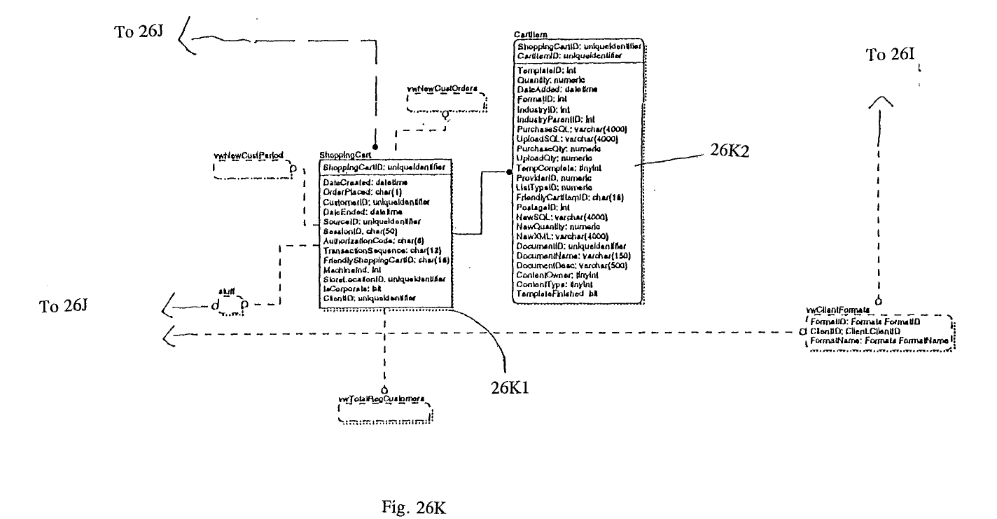

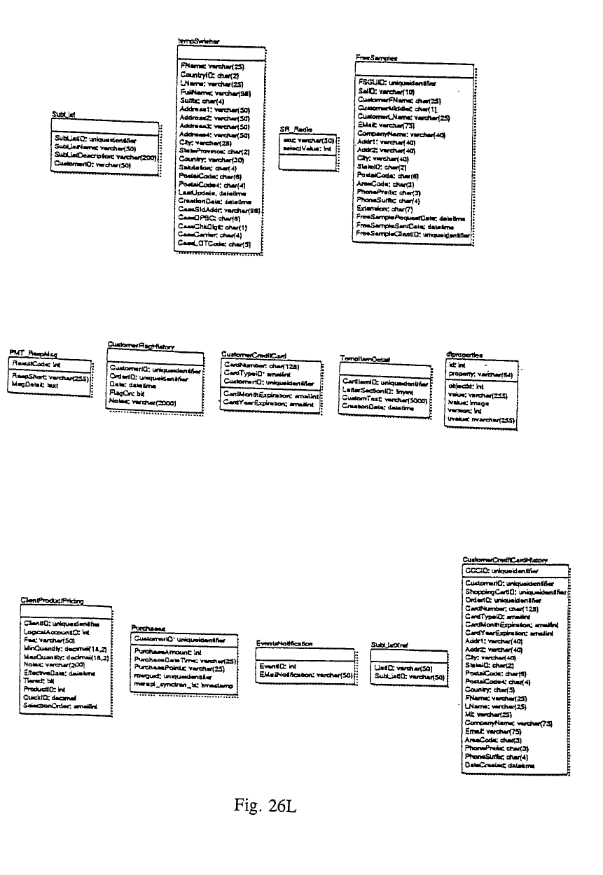

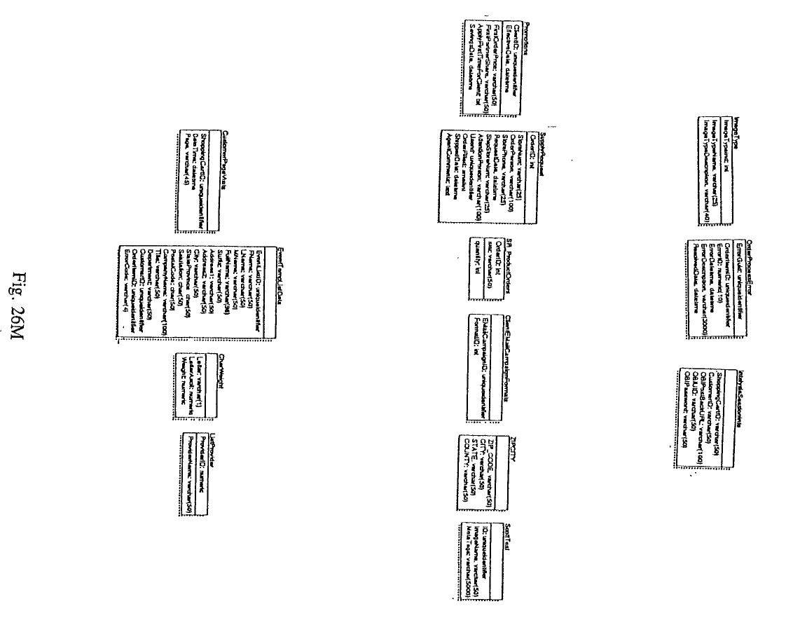

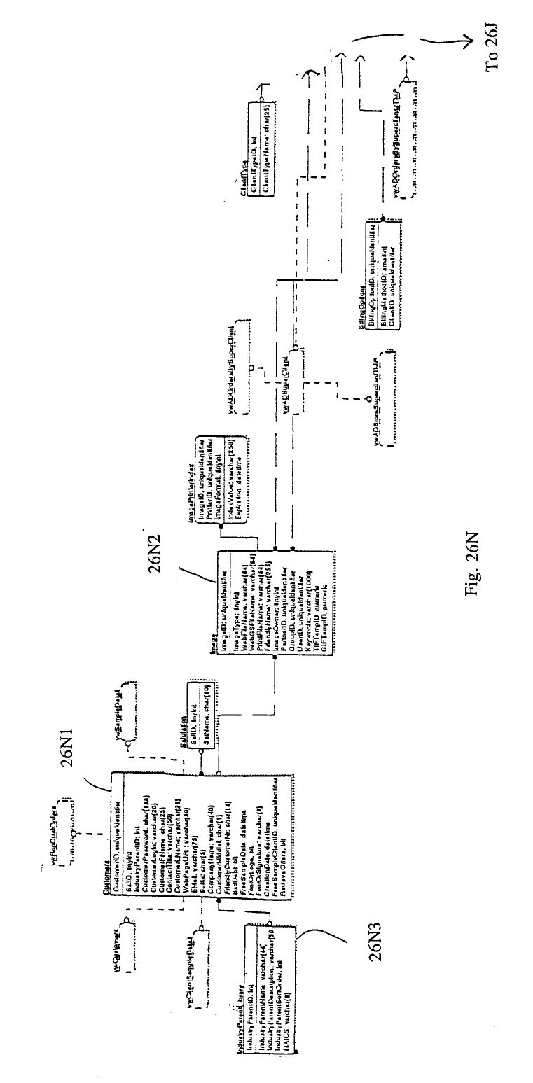

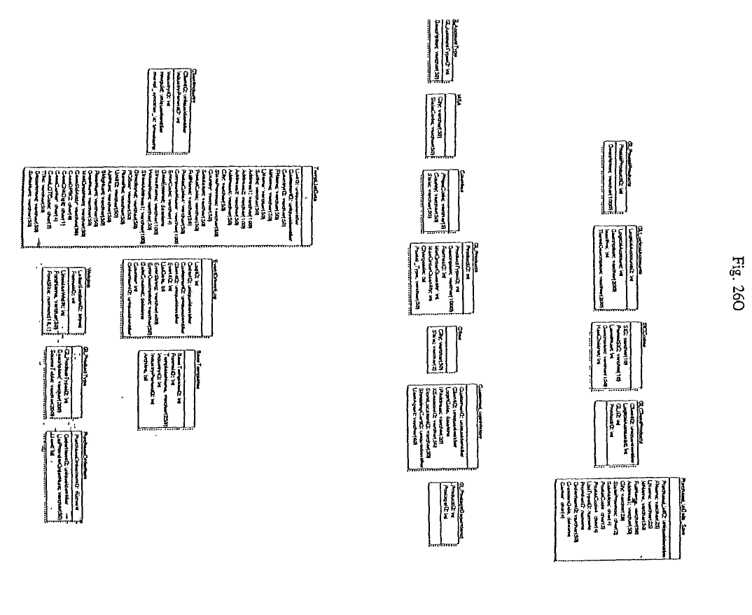

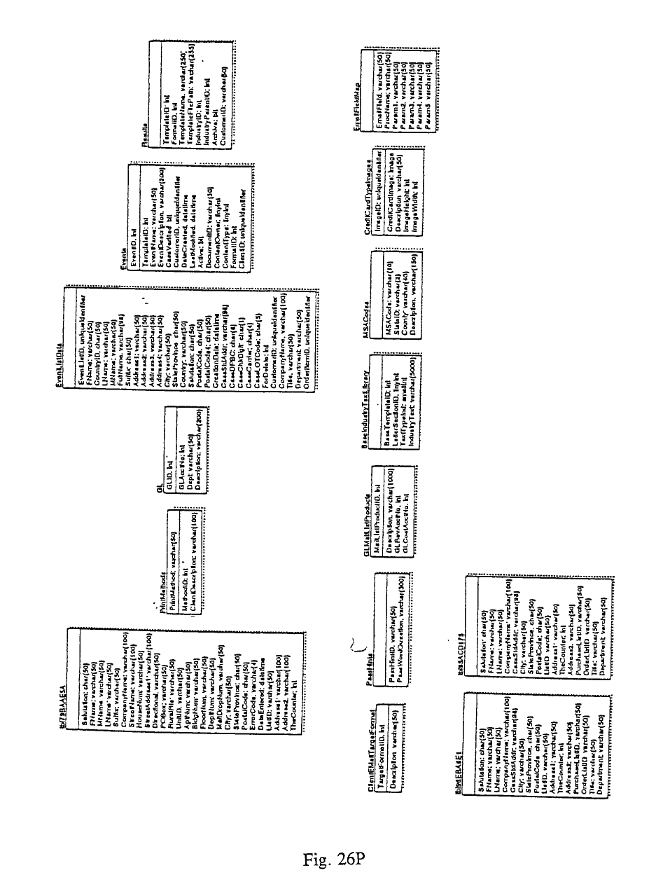

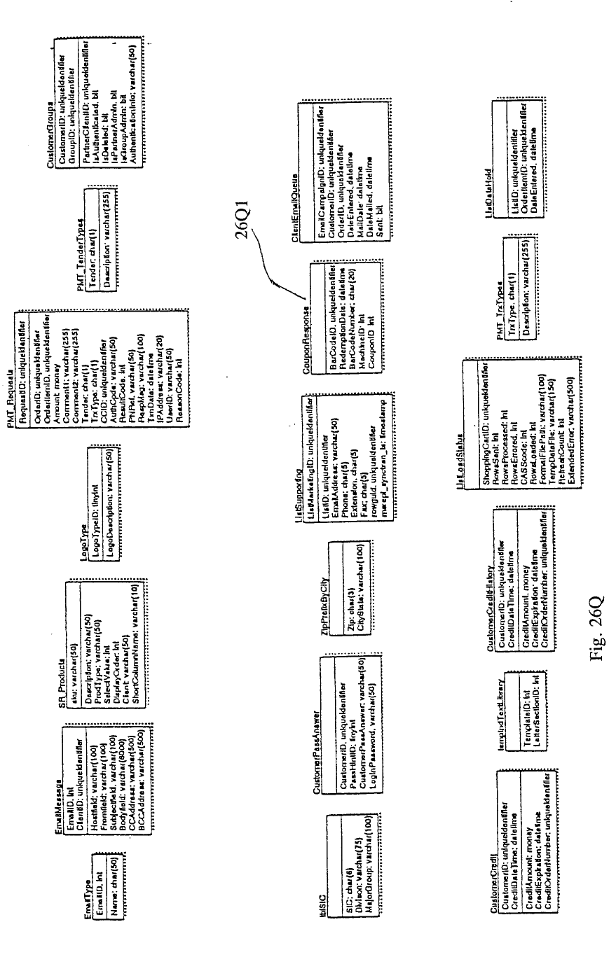

An example database 600, corresponding to database 560, is shown in FIG. 25. A preferred implementation of database 600 is shown in detail in FIGS. 26A-26Q. Preferably, database 600 is a relational database comprising a plurality of tables that include client, template, customer list, user profile, and other types of related information. Using this structure, the database provides accessible information relating to e-commerce transactions, execution, and history. In addition, the database includes security and administration capabilities. In this manner, the database provides configuration information for corporate clients. Further, in accordance with a preferred aspect of the present invention, the database provides list management and response analysis. The database also provides general accounting and pricing information.

As shown in a high level, database 600 can include related tables that provide accounting information 610, response analysis information 620, coupon barcode ID information 630, client configuration information 640, orders information 650, order items information 660, customers/profiles information 670, customer list information 680, and purchase list information 690. The tables store the aforementioned information in the form of records, where the tables can be related by keys. For example, when a client submits a new order, order items are identified, customers can be selected from old or new customer lists, and customer information from private libraries can be keyed. This particular information is then used to generate new data, namely a new coupon ID for a particular direct mail piece, that is stored in the database and that can be used for response tracking analysis. This barcode ID can link the client to the customer to the order to the product, and so on.

In greater detail, a preferred relational database is shown in FIGS. 26A-26Q. In these figures, Tables are identified by title, with primary and foreign keys (if shown) listed above the internal horizontal lines of the tables. The types of records are apparent from their labels. The information contained in the example database can be utilized in a manner consistent with the previous description herein. Other structures for the database will become apparent to those of ordinary skill in the art given the present description.

The following is a brief description of some of the features of a preferred relational database structure according to this embodiment of the present invention. For simplicity, a limited number of the tables shown in FIGS. 26A through 26Q will be described. The description is representative and is not meant to limit the scope of the preferred database shown in the figures. Given the present description, the information provided by and other features of the remaining tables will be apparent to one of skill in the art.

For example, client configuration information is shown in FIG. 26J. This information includes Client table 26J1, Client Pricing table 26J2, Credit Card Types table 26J3, Client-Sub table 26J4, Store Locations table 26J5, and Account Access table 26J6. In this structure, tables are linked via foreign keys, such as ClientID, StoreLocationID, and ClientSubID, which are unique identifiers. Other tables and records can also be provided as shown in FIG. 26J.

In this example, user profile information and image libraries can be included in the tables shown in FIG. 26N. This information can include a Customers table 26N1, which provides a CustomerID (unique identifier) key and an Image table 26N2, which references user images stored in the database. Other information, such as an Industry Parent Library, can also be included.

FIGS. 26H, 26I, and 26K show tables providing order, order item, and fulfillment information. For example, an Orders table 26H1, with its associated records, is shown in FIG. 26H. In addition, an Order Status table 26H2 and an Order Status History table 26H3 can also be included in the database. FIG. 26I shows an Order Item table 26I1 that provides an OrderItenID key. As shown, the Order Item table utilizes record information from various other tables within the database to store information concerning a particular order. In FIG. 26K, a Shopping Cart table 26K1 and a Cart Item table 26K2 are shown, to provide and store further information concerning a particular client order.

In addition, as shown in FIGS. 26B and 26Q, customer list and coupon identification information can be provided. For example, FIG. 26B shows List Data table 26B1 and Order List table 26B2. In FIG. 26Q, a Coupon Response table 26Q1 is shown. This table includes the BarCodeID unique identifier record, which can be used for response analysis.

Further, general accounting information is maintained in the database, as shown in FIGS. 260 and 26P. For example, the tables headings beginning with the prefix “GL” can be used for accounting purposes, as would be apparent to one of ordinary skill in the art given the present description.

In addition, template information can be stored as shown in Templates table 26F1, shown in FIG. 26F. Further, an Order List Information table 26F2 is also shown in FIG. 26F.

Thus, a targeted advertising method and system have been described according to the embodiments of the present invention. The targeted advertising method and system provide on-line or Internet-based services which offer clients the ability to compose, print, address, and deliver customized advertising and/or promotional materials to selected addressees. In addition, the centralized design of the above system and method can provide fast and accurate service in a timely and cost-effective manner. Further, the system and method provides an enclosed or closed-loop system that allows a client to automatically receive information concerning the effectiveness of the selected advertising and/or promotional campaign when desired. The method and system provide a response analysis process that can directly tie a particular customer to a particular purchase (i.e., an actual response) in a fully integrated manner. With this capability, a client can better target and fully tailor subsequent advertising and promotional campaigns. In addition, the targeted advertising method and system of the present invention provides both corporate and localized marketing capabilities.

While the above provides a full and complete disclosure of the preferred embodiments of the present invention, various modifications, alternate constructions, and equivalents may be employed without departing from the scope of the invention. Therefore, the above description and illustration should not be construed as limiting the scope of the invention, which is defined by the appended claims.

What is claimed is:

1. A method of targeted advertising, comprising:
generating a targeted advertising and/or promotional campaign material at a central facility corresponding to a client's selections;
fulfilling the targeted advertising and/or promotional campaign material, wherein the targeted advertising and/or promotional campaign material includes a response tracking capability; and
providing a response tracking analysis to the client.

2. The method according to claim 1, further comprising:
providing access for the client to contact a central facility on-line via a client web site;
providing a set of options for the client to choose from in selecting a design of the targeted advertising and/or promotional campaign material; and
providing a set of options for the client to choose from in selecting intended recipients of the targeted advertising and/or promotional campaign material.

3. The method according to claim 1, wherein the fulfilling step comprises:
manufacturing the targeted advertising and/or promotional campaign material, wherein the advertising and/or promotional campaign material is at least one material selected from the group consisting of a document, a direct mail letter, a coupon, a flyer, and a postcard: and
distributing the targeted advertising and/or promotional campaign material to intended recipients.

4. The method according to claim 3, wherein the at least one material includes a coupon having a machine readable mark, symbol, or barcode that incorporates information relating to the client, the customer, and the advertising and/or promotional campaign.

5. The method according to claim 4, wherein the machine readable mark, symbol, or barcode is scanned and the information incorporated on the machine readable mark, symbol, or barcode is electronically stored by a party receiving the coupon.

6. The method according to claim 5, wherein the scanned coupon is communicated back to the central facility and the client is notified by the central facility as to response characteristics of the advertising and/or promotional campaign.

7. The method according to claim 1, wherein response tracking capability allows the client to determine whether a particular customer received and utilized the advertising and/or promotional campaign material.

8. A method of generating an advertisement, comprising:
providing a client access to a central facility to create an advertising and/or promotional material;
providing a database administered by the central facility that includes an electronically storable advertising and/or promotional template from which the client selects the format and content of the advertising and/or promotional material;
providing a customer list from which the client selects targeted customers of the advertising and/or promotional material;
processing data corresponding to the selected advertising and/or promotional material and data corresponding to the selected targeted customers;
providing an order that identifies the processed advertising and/or promotional material data and targeted customer data;
communicating the order for fulfillment;
processing response tracking data that relates the client, a particular customer from the targeted customers, and the order; and
generating the advertising and/or promotional material in communicable form for receipt by the targeted customers, wherein the communicable form includes a machine readable mark or code that includes the response tracking data.

9. The method according to claim 8, wherein the advertising and/or promotional material is a direct mail document printed in the form of a letter, flyer, coupon, or postcard.

10. The method according to claim 8, wherein the advertising and/or promotional material is an electronic mail (e-mail) message, and wherein the targeted e-mail message is generated and prepared to send to e-mail addresses of the targeted customers.

11. The method according to claim 8, wherein the response tracking data includes data related to the order name, the particular customer's name, the client's name, and the order type.

12. The method according to claim 8, wherein the machine readable mark or code is printed on the communicable form of the advertising and/or promotional material.

13. The method according to claim 8, further comprising:
communicating the advertising and/or promotional material to customers via mail, courier service, voice, fax, digital communication or electronic mail.

14. The method according to claim 8, wherein client access to the central facility is provided by an on-line (dial-up) or an internet-based communications channel.

15. The method according to claim 8, wherein client access to the central facility is provided by a closed intranet communications channel.

16. The method according to claim 8, wherein the client selected template is stored in a private database library related to the client.

17. The method according to claim 8, further comprising:
providing an underlying XML document that defines the targeted advertising and/or promotional material that is an accurate representation of the communicable form of the advertising and/or promotional material.

18. The method according to claim 8, further comprising:
providing a previously used customer list that is stored in a private client library at the central facility.

19. The method according to claim 8, further comprising:
providing the client with a new customer list based on client selections related to demographic characteristics of the targeted customers.

20. A method of fulfilling an order for a targeted advertisement, comprising:
generating an order for a targeted advertisement, the order containing data related to the form and content of the targeted advertisement and data related to intended recipients of the directed advertisement;
placing an order file corresponding to the order in an orders subdirectory at a first site;
periodically checking for order files in the orders subdirectory at the first site;
determining whether any files exist in the orders subdirectory;
if the determination is yes, downloading a first file from the first site into a download file at a second site and moving the first file from the orders subdirectory to a history subdirectory at the first site;
if the determination is no, then further determining whether there is a notification file that includes status and shipping information for placed orders;
if the further determination is no, then returning to said checking for order files step;
if the further determination is yes, uploading the notification file to a notification file subdirectory at the first site and placing the uploaded notification file in a local subdirectory at the second site;
monitoring the notification subdirectory such that when a file is placed in the notification subdirectory, date time data is extracted from the order file and a corresponding database is updated; and
further monitoring the history subdirectory such that when a file is placed the history subdirectory, the corresponding database is updated with a date time stamp that the order was picked up by the second site.

21. The method according to claim 20, further comprising:
unzipping/unpackaging the first file to extract data for printing at the second site; and
printing the targeted advertisement based on the extracted data.

22. The method according to claim 21, wherein the data related to the form and content of the targeted advertisement is in XML form and the data related to intended recipients of the directed advertisement is in a flat ASCII file.

23. The method according to claim 20, further comprising:
notifying the first site that the order has been picked up; and
updating the database.

24. A system for generating a client selected targeted advertisement, comprising:
a communication port for receiving a communication line accessed by the client;
a primary domain controller coupled to a central facility to interface the client to the central facility through software;
a relational database in communication with the primary domain controller via a bus to provide list management, client configuration and response tracking capabilities to the central facility, wherein the relational database includes at least one client data library, at least one template library, a response tracking library, and at least one customer list library;
an application server to handle application operations exchanged through the bus between the software and the relational database, wherein when the accesses the central facility, the client is provided with a set of options for the client to choose from in selecting a design of the targeted advertising and/or promotional campaign material, and wherein the client is provided with a set of options for the client to choose from in selecting intended recipients of the targeted advertising and/or promotional campaign material.

25. The system according to claim 24, further comprising a second communication port to provide a communication channel from the central facility to a customer list provider service.

26. The system according to claim 24, wherein the central facility generates an order that identifies processed advertising and/or promotional material data and targeted customer data corresponding to the client's selections.

27. The system according to claim 26, further comprising:
a third communication port to provide communications of the order to a fulfillment center, wherein the fulfillment center prints the selected targeted advertising and/or promotional campaign material and distributes the targeted advertising and/or promotional campaign material to intended recipients, and wherein the printed targeted advertising and/or promotional campaign material includes a machine readable mark or code incorporating information relating to the order, the client, and the customer recipient.

28. The system according to claim 26, wherein the machine readable mark or code is a bar code that comprises a first portion that includes the name of the client order/offer; a second portion that includes the name of the customer that the targeted advertising and/or promotional campaign material was mailed to; a third portion that includes the type of order; and a fourth portion that includes the mailing date of the targeted advertising and/or promotional campaign material.

29. The system according to claim 27, wherein an order file corresponding to the order is placed in an orders subdirectory at the central facility, wherein the fulfillment center checks for order files in the orders subdirectory at the central facility in timed intervals; wherein if an order file is present in the orders subdirectory, a first file is downloaded from the central facility to the fulfillment center and wherein the central facility moves the first file from the orders subdirectory to a history subdirectory at the central facility.

30. The system according to claim 29, wherein the fulfillment center determines whether there is a notification file that includes status and shipping information for placed orders if no order file is present in the orders subdirectory during the checking, wherein if a notification file is present, the fulfillment center uploads the notification file to a notification file subdirectory at the central facility and places the uploaded notification file in a local subdirectory at the fulfillment center.

31. The system according to claim 29, wherein the central facility monitors the notification subdirectory such that when a file is placed in the notification subdirectory, date time data is extracted from the order file and the relational database is updated, and wherein the central facility monitors the history subdirectory such that when a file is placed the history subdirectory, the corresponding database is updated with a date time stamp that the order was picked up by the fulfillment center.
